(19) United States
(12) Patent Application Publication
(10) Pub. No.: US 2024/0002562 A1
(43) Pub. Date: Jan. 4, 2024

(54) METHOD FOR MAKING A POLY(ETHYLENE-CO-1 -ALKENE) COPOLYMER WITH REVERSE COMONOMER DISTRIBUTION

(71) Applicant: Dow Global Technologies LLC, Midland, MI (US)

(72) Inventors: Ruth Figueroa, Midland, MI (US); Leslie E. O'Leary, Sugar Land, TX (US); Susan Brown, Pearland, TX (US); Joseph F. Dewilde, King of Prussia, PA (US); Jerzy Klosin, Midland, MI (US); Andrew J. Young, Houston, TX (US); Rhett A. Baillie, Pearland, TX (US)

(21) Appl. No.: 18/254,736

(22) PCT Filed: Feb. 10, 2022
(86) PCT No.: PCT/US2022/015933

§ 371 Date: May 26, 2023

Related U.S. Application Data
(60) Provisional application No. 63/149,488, filed on Feb. 15, 2021.

(51) Int. Cl. C08F 210/16

(52) U.S. Cl. CPC C08F 210/16

(57) ABSTRACT

A method of making a poly(ethylene-co-1-alkene) copolymer having a reverse comonomer distribution, the method comprising contacting ethylene and at least one 1-alkene with an effective catalyst therefor under effective gas-phase or slurry-phase polymerization conditions, thereby making the poly(ethylene-co-1-alkene) copolymer having a reverse comonomer distribution; wherein the effective catalyst is made by contacting a ligand-metal complex of formula (I), as described herein, with an activator under activating conditions.

### FIELD

Olefin polymerization catalysts and processes and polyethylene copolymers.

### INTRODUCTION

Patent application publications and patents in or about the field include EP 1 778 738 A1; EP 2 121 776 A1; EP 2 609 123 A1; U.S. Pat. Nos. 8,455,601 B2; 8,609,794 B2; 8,835,577 B2; 9,000,108 B2; 9,029,487 B2; 9,234,060 B2; US 2009/0306323 A1; US 2017/0081444 A1; US 2017/0101494 A1; US 2017/0137550 A1; US 2018/0282452 A1; US 2018/0298128 A1; WO 2009/064404 A2; WO 2009/064452 A2; WO 2009/064482 A1; WO 2011/087520 A1; WO 2012/027448; WO 2013/070601 A2; WO 2016/172097 A1; WO 2017/058858; and WO 2018/022975 A1.

Most poly(ethylene-co-1-alkene) copolymers have comonomer contents (i.e., weight fraction amounts of constituent units derived from the 1-alkene that are in the copolymer) that vary with molecular weight of the constituent macromolecules thereof. Basically, if a higher molecular weight fraction of macromolecules has lower wt % comonomer content than that of a lower molecular weight fraction, this is a normal comonomer distribution versus molecular weight. The normal comonomer distribution is also referred to as a normal short-chain branching distribution (normal SCBD) or normal molecular weight comonomer distribution index (normal MWCDI). If MWCDI is less than 0, there is a normal MWCDI or normal SCBD. If MWCDI=0, there is a flat MWCDI or flat SCBD. Normal comonomer distributions are common.

Alternatively, if the higher molecular weight fraction has higher wt % comonomer content than that of the lower molecular weight fraction, this is a reverse comonomer distribution versus molecular weight. This is also referred to as a reverse short-chain branching distribution (reverse SCBD), reverse molecular weight comonomer distribution index (reverse MWCDI), or broad-orthogonal composition distribution (BOCD). If MWCDI is greater than 0, there is a reverse comonomer distribution or reverse SCBD. Reverse comonomer distributions are uncommon.

These comonomer content distributions across molecular weights are shown by plotting a linear regression of the comonomer content in weight percent (wt %) on a y-axis versus Log(M) on an x-axis. The wt % comonomer content is determined by rapid Fourier Transform-Infrared (FT-IR) spectroscopy on dissolved copolymer in a gel permeation chromatography (GPC) measurement using an infrared detector. M is the specific x-axis molecular weight point, (10\hat{ }[Log(M)]) of a Flory distribution of molecular weight, as measured by GPC. In such a plot, the normal comonomer distribution has a negative slope (i.e., a line fitted to data points going from lower Log(M) values to higher Log(M) values (from left to right on the x-axis) slopes downward).

### SUMMARY

In practice making a poly(ethylene-co-1-alkene) copolymer having a reverse comonomer distribution requires using a single catalyst in multiple reactors with different polymerization conditions or multiple catalysts in a single reactor under steady-state polymerization conditions. If a single catalyst is used in multiple reactors, first polymerization conditions in a first reactor may make a lower molecular weight (LMW) poly(ethylene-co-1-alkene) copolymer having a lower comonomer content and different second polymerization conditions in a second reactor may make a higher molecular weight (HMW) poly(ethylene-co-1-alkene) copolymer having a higher comonomer content. Alternatively, if the single catalyst is used in multiple reactors, first polymerization conditions in a first reactor may make a higher molecular weight (HMW) poly(ethylene-co-1-alkene) copolymer having a higher comonomer content and second polymerization conditions in a second reactor may make a lower molecular weight (LMW) poly(ethylene-co-1-alkene) copolymer having a lower comonomer content. The LMW poly(ethylene-co-1-alkene) copolymer having a higher comonomer content may be made in the absence or presence of the HMW poly(ethylene-co-1-alkene) copolymer having a lower comonomer content. If multiple catalysts are used in a single reactor under steady-state polymerization conditions, a first catalyst is chosen for making the LMW poly(ethylene-co-1-alkene) copolymer having the lower comonomer content and a second catalyst is chosen for making the HMW poly(ethylene-co-1-alkene) copolymer having the higher comonomer content under those polymerization conditions. In either embodiment, the making LMW and HMW poly(ethylene-co-1-alkene) copolymers has given a poly(ethylene-co-1-alkene) copolymer having a reverse comonomer distribution and a bimodal molecular weight distribution.

Making a poly(ethylene-co-1-alkene) copolymer having a reverse comonomer distribution and a true unimodal molecular weight distribution is challenging. It requires using a single reactor under steady-state polymerization conditions and a suitable single catalyst that effectively functions to build molecular weight of copolymer molecules containing higher comonomer content more than building molecular weight of copolymer molecules containing lower comonomer content. Such catalysts are rare. Making a different poly(ethylene-co-1-alkene) copolymer having both a reverse comonomer distribution and a unimodal molecular weight distribution would require using different steady-state polymerization conditions and/or a different suitable catalyst. To be suitable the polymerization conditions either enhance such a selective molecular weight build or partially inhibit the build without negating it completely.

Whether any given catalyst could function to make a poly(ethylene-co-1-alkene) copolymer having a reverse comonomer distribution and a unimodal molecular weight distribution is unpredictable. For example, results from a solution-phase polymerization may not predict results from a gas-phase or slurry-phase polymerization with the same catalyst.

Unexpectedly, we discovered a small subgenus of effective catalysts wherein each effective catalyst of the subgenus independently is capable of making a poly(ethylene-co-1-alkene) copolymer having a reverse comonomer distribution and a unimodal molecular weight distribution. Each effective catalyst functions in this way even if the effective catalyst is the only catalyst and if the polymerization is run in a single gas-phase polymerization reactor under effective steady-state gas-phase polymerization conditions or if the polymerization is run in a single slurry-phase polymerization reactor under effective steady-state slurry-phase polymerization conditions. Each effective catalyst of the subgenus can also make a different poly(ethylene-co-1-alkene) copolymer having a reverse comonomer distribution and a unimodal molecular weight distribution in the single gas-phase or slurry-phase polymerization reactor under different steady-state polymerization conditions, respectively. Two or more of the subgenuses of effective catalysts, or one of the subgenuses of effective catalysts and at least one different catalyst (e.g., a metallocene or a bis((alkyl-substituted phenylamido)ethyl)amine catalyst), can also function in gas-phase or slurry-phase polymerization to make a poly(ethylene-co-1-alkene) copolymer having a reverse comonomer distribution and a multimodal molecular weight distribution. We provide the subgenus of effective catalysts and the foregoing methods of making and using same.

The poly(ethylene-co-1-alkene) copolymer having a reverse comonomer distribution and, optionally, the unimodal molecular weight distribution, is useful for making manufactured articles and components thereof comprising the poly(ethylene-co-1-alkene) copolymer having a reverse comonomer distribution.

We provide a method of making a poly(ethylene-co-1-alkene) copolymer having a reverse comonomer distribution (MWCDI>0), the method comprising contacting ethylene and at least one 1-alkene (comonomer(s)) with an effective catalyst therefor under effective gas-phase or slurry-phase polymerization conditions, thereby making the poly(ethylene-co-1-alkene) copolymer having a reverse comonomer distribution; wherein the effective catalyst is made by contacting a ligand-metal complex of formula (I):

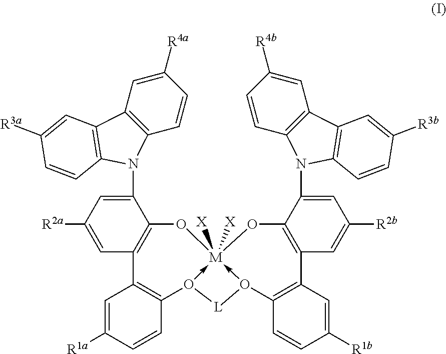

with an activator under activating conditions; wherein L, M, R^{1a} to R^{4b}, and X are as defined hereinbelow. The effective catalyst made by the activating of the metal-ligand complex of formula (I) with the activator enables the making of the poly(ethylene-co-1-alkene) copolymer having a reverse comonomer distribution (MWCDI>0), including embodiments of the poly(ethylene-co-1-alkene) copolymer having a reverse comonomer distribution (MWCDI>0) and also having a unimodal molecular weight distribution.

### BRIEF DESCRIPTION OF THE DRAWING(S)

FIG. 1 graphically illustrates a normal comonomer distribution and a reverse comonomer distribution (sloped lines) and molecular weight distributions (bell-shaped curves) for general comparison purposes.

FIG. 2 graphically depicts reverse comonomer distributions (sloped lines) and molecular weight distributions (bell-shaped curves) of inventive Examples 1 and 8, which are made using spray-dried catalyst system sdCat1 described later.

FIG. 3 graphically depicts reverse comonomer distributions (sloped lines) and molecular weight distributions (bell-shaped curves) of inventive Examples 2 and 9, which are made using spray-dried catalyst system sdCat1 described later.

FIG. 4 graphically depicts reverse comonomer distributions (sloped lines) and molecular weight distributions (bell-shaped curves) of inventive Examples 10 and 11, which are made using conventionally-dried catalyst system cdCat1 described later.

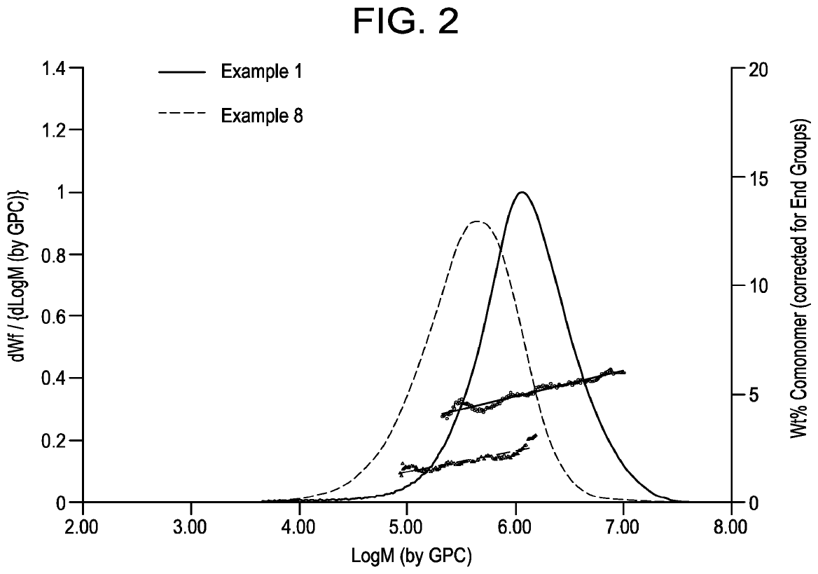

Choice of each respective pair of the inventive examples in FIGS. 2 to 4 is based on (a) the examples being made using same catalyst system and (b) readability (minimized overlap) of the plots. Other than that the parings do not imply any special relationship between the two examples chosen.

### DETAILED DESCRIPTION

A method of making a poly(ethylene-co-1-alkene) copolymer having a reverse comonomer distribution, the method comprising contacting ethylene and at least one 1-alkene (comonomer(s)) with an effective catalyst therefor under effective gas-phase or slurry-phase polymerization conditions, thereby making the poly(ethylene-co-1-alkene) copolymer having a reverse comonomer distribution; wherein the effective catalyst is made by contacting the ligand-metal complex of formula (I) described above with an activator under activating conditions. In some aspects L is a divalent group selected from an unsubstituted 1,3-propan-di-yl (i.e., —CH₂CH₂CH₂—) or an alkyl-substituted 1,3-propan-di-yl (e.g., —CH(CH₃)CH₂CH(CH₃)—); M is a Group 4 metal; each of R^{1a} and R^{1b} independently is an electron withdrawing group; and each of R^{2a}, R^{2b}, R^{3a}, R^{3b}, R^{4a}, and R^{4b} independently is a hindered alkyl group; and at least one X is a group displaceable by ethylene (H₂C═CH₂). The effective catalyst made by the activating of the metal-ligand complex of formula (I) with the activator enables the making of the poly(ethylene-co-1-alkene) copolymer having a reverse comonomer distribution (MWCDI>0), including embodiments of the poly(ethylene-co-1-alkene) copolymer having a reverse comonomer distribution (MWCDI>0) and also having a unimodal molecular weight distribution.

The term “effective catalyst therefor” or, simply, “effective catalyst” means a material that is capable, when used as the only catalyst in a single polymerization reactor under effective steady-state gas-phase or slurry-phase polymerization process conditions, of making the poly(ethylene-co-1-alkene) copolymer having a reverse comonomer distribution and a unimodal molecular weight distribution.

In other embodiments the effective catalyst may be used as the only catalyst in multiple polymerization reactors and the poly(ethylene-co-1-alkene) copolymer having a reverse comonomer distribution has a multimodal molecular weight distribution (“first multimodal poly(ethylene-co-1-alkene) copolymer having a reverse comonomer distribution”).

In other embodiments the effective catalyst may be used as one, but not more than one, of at least two different catalysts of a multimodal catalyst system in a single polymerization reactor under effective steady-state polymerization process conditions and the poly(ethylene-co-1-alkene) copolymer having a reverse comonomer distribution has a multimodal molecular weight distribution (“second multimodal poly(ethylene-co-1-alkene) copolymer having a reverse comonomer distribution”).

The expression “effective gas-phase or slurry-phase polymerization” refers to making polymer in the form of growing solid particulates dispersed in a continuous fluid phase selected from a gas or liquid, respectively. Such a polymerization is different than solution-phase polymerization, which makes polymer in the form of growing solute macromolecules dissolved in a solvent.

The expression “effective gas-phase or slurry-phase polymerization process conditions” means steady-state values for gas-phase polymerizations or slurry-phase polymerizations, respectively, that either enhance such a selective molecular weight build or partially inhibit the build without negating it completely. As detailed later, the set of effective gas-phase polymerization conditions may comprise temperature of a resin bed in a gas-phase polymerization (GPP) reactor (“bed temperature”); partial pressure of ethylene (C₂) in the GPP reactor; a 1-alkene-to-ethylene (Cₓ/C₂) molar ratio of the feeds of 1-alkene and ethylene going into the GPP reactor, wherein Cₓ indicates the 1-alkene; and, if hydrogen (H₂) is used, a hydrogen-to-ethylene (H₂/C₂) molar ratio of the feeds of hydrogen and ethylene going into the GPP reactor. The gas-phase polymerization conditions may further comprise one or more of a concentration of an induced condensing agent (ICA) used in the GPP reactor, a superficial gas velocity in the GPP reactor, total pressure in the GPP reactor, a catalyst productivity of the effective catalyst being used in the GPP reactor, a production rate of the copolymer being made in the GPP reactor, or an average residence time of the poly(ethylene-co-1-alkene) copolymer in the GPP reactor. The effective slurry-phase polymerization conditions may comprise temperature of the slurry-phase polymerization (SPP) reactor, partial pressure of ethylene (C₂) in the SPP reactor, Cₓ/C₂ molar ratio of the feeds of 1-alkene and ethylene going into the SPP reactor and H₂/C₂ molar ratio of the feeds of hydrogen and ethylene going into the SPP reactor.

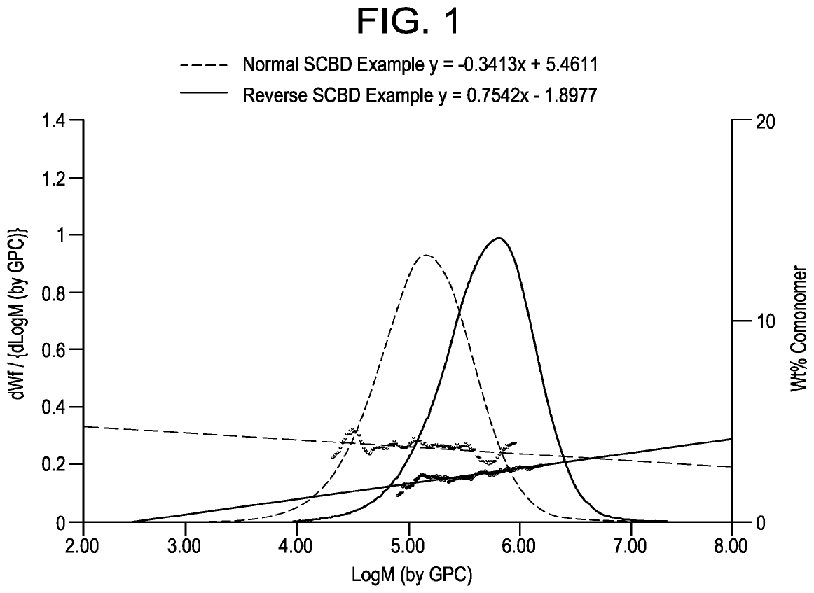

The expression “normal comonomer distribution” means having a molecular weight comonomer distribution index less than 0 (MWCDI<0). The expression “reverse comonomer distribution” means having a molecular weight comonomer distribution index greater than 0 (MWCDI>0). The MWCDI value is determined from a plot of SCB per 1000 carbon atoms versus Log(weight-average molecular weight) (Log(M_{w}). See US 2017/008444 A1, paragraphs [0147] to [0150]. Illustrations of a normal comonomer distribution (dashed fitted straight line) and a reverse comonomer distribution (solid fitted straight line) for poly(ethylene-co-1-alkene) copolymers are shown in FIG. 1. Also shown in FIG. 1 are a bell-shaped curve showing unimodal molecular weight distribution for the poly(ethylene-co-1-alkene) copolymer having the normal comonomer distribution (dashed bell-shaped line) and a bell-shaped curve showing unimodal molecular weight distribution for the poly(ethylene-co-1-alkene) copolymer having the reverse comonomer distribution (solid bell-shaped line).

Additional inventive aspects follow; some are numbered below for ease of reference.

Aspect 1. A method of making a poly(ethylene-co-1-alkene) copolymer having a reverse comonomer distribution, the method comprising contacting ethylene and at least one 1-alkene (comonomer(s)) with an effective catalyst therefor in a gas-phase or slurry-phase polymerization reactor under effective gas-phase or slurry-phase polymerization conditions, respectively, so as to give the poly(ethylene-co-1-alkene) copolymer having a reverse comonomer distribution as shown by a molecular weight comonomer distribution index greater than 0 (MWCDI>0); wherein the effective catalyst is made by contacting a ligand-metal complex of formula (I):

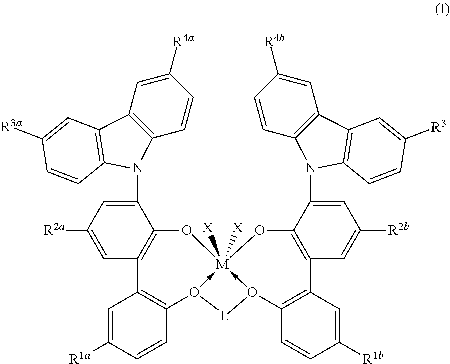

with an activator under effective activating conditions to give the effective catalyst; wherein L is CH₂CH₂CH₂ or an alkyl-substituted 1,3-propan-di-yl; M is an element of Group 4 of the Periodic Table of the Elements; each of R^{1a} and R^{1b} independently is a halogen; and each of R^{2a}, R^{2b}, R^{3a}, R^{3b}, R^{4a}, and R^{4b} independently is an unsubstituted 1,1-dimethyl-(C₂ to C₈)alkyl; and each X independently is a halogen, a (C₁-C₂₀)alkyl, a (C₇-C₂₀)aralkyl (e.g., benzyl), a (C₁-C₆)alkyl-substituted (C₆-C₁₂)aryl, or a (C₁-C₆)alkyl-substituted benzyl. In some aspects M is hafnium (Hf) or zirconium (Zr), alternatively Hf. The poly(ethylene-co-1-alkene) copolymer having a reverse comonomer distribution may have a unimodal molecular weight distribution. As evident from the formula (I), the effective catalyst is not a metallocene catalyst or a bis((alkyl-substituted phenylamido)ethyl)amine catalyst.

Aspect 2. The method of aspect 1 wherein the ligand-metal complex of formula (I) has any one of features (i) to (vii): (i) L is CH₂CH₂CH₂; (ii) L is the alkyl-substituted 1,3-propan-di-yl (e.g., —CH(CH₃)CH₂CH(CH₃)—); (iii) M is hafnium (Hf); (iv) each of R^{1a} and Rib is F; (v) each of R^{2a} and R^{2b} is unsubstituted 1,1,3,3-teramethyl-butyl; (vi) each of R^{3a}, R^{3b}, R^{4a}, and R^{4b} is unsubstituted 1,1-dimethylethyl; and (vii) each X is unsubstituted (C₁-C₈)alkyl or benzyl. In some aspects the ligand-metal complex of formula (I) has a combination of at least two such features. The combination of features may be any one of features (viii) to (xvi): (viii) both (i) and any one of (ii) to (vii); (ix) both (ii) and any one of (iii) to (vii); (x) both (iii) and any one of (iv) to (vii); (xi) both (v) and any one of (vi) to (vii); (xii) both (vi) and (vii); (xiii) any five of features (i) to (vi); (xiv) any six of features (i) to (vii); (xv) each of features (i) to (vi); and (xvi) each of features (i) to (vii). In some embodiments each X may be methyl or benzyl, alternatively methyl.

Aspect 3. The method of aspect 1 or 2 wherein the ligand-metal complex of formula (I) is selected from complex (1) and complex (2): complex (1) is the ligand-metal complex of formula (I) wherein M is Hf; L is CH₂CH₂CH₂; each of R^{1a} and R^{1b} is F; each of R^{2a} and R^{2b} is unsubstituted 1,1,3,3-teramethyl-butyl; each of R^{3a}, R^{3b}, R^{4a}, and R^{4b} is unsubstituted 1,1-dimethylethyl; and each X independently is a halogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl; and complex (2) is ligand-metal complex of formula (I) wherein M is Hf; L is —CH(CH₃)CH₂CH(CH₃)—; each of R^{1a} and R^{1b} is F; each of R^{2a} and R^{2b} is unsubstituted 1,1,3,3-teramethyl-butyl; each of R^{3a}, R^{3b}, R^{4a}, and R^{4b} is unsubstituted 1,1-dimethylethyl; and each X independently is a halogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl. In some embodiments each X may be methyl or benzyl, alternatively methyl.

Aspect 4. The method of aspect 3 wherein the ligand-metal complex of formula (I) is the complex (1).

Aspect 5. The method of any one of aspects 1 to 4 wherein the poly(ethylene-co-1-alkene) copolymer has a reverse comonomer distribution wherein the MWCDI>0.05 to 4, alternatively from 0.20 to 4.0, alternatively from 0.20 to 3.44, alternatively from 0.20 to 3.20, alternatively from 0.23 to 2.94, alternatively from 1.01 to 3.20, alternatively from 2.01 to 3.20, alternatively from 3.01 to 4.00, alternatively from 0.23 to 1.00, alternatively from 1.01 to 2.00, alternatively from 2.01 to 3.00, alternatively from 3.01 to 4.00, alternatively from 0.35 to 1.60, alternatively from 0.20 to 1.34, alternatively from 1.65 to 3.20. In some aspects the MWCDI range has a lower endpoint that is equal to any one of the MWCDI values of the Examples 1 to 20 described later. In some aspects the MWCDI range has an upper endpoint that is equal to any one of the MWCDI values of the Examples 1 to 20 described later.

Aspect 6. The method of any one of aspects 1 to 5 having any one of features (i) to (iii): (i) the activator is an alkylaluminoxane; (ii) the effective catalyst is a supported catalyst that comprises the effective catalyst and a support material that is a solid particulate effective for hosting the ligand-metal complex of formula (I) and its active product, wherein the effective catalyst is disposed on the support material; and (iii) both (i) and (ii). In some aspects the effective catalyst is made by contacting a mixture of the ligand-metal complex of formula (I) and the support material with the activator under the activating conditions. The alkylaluminoxane may be any one of the alkylaluminoxanes described later or a combination of any two or more thereof. In some aspects the alkylaluminoxane is a methylaluminoxane (MAO), alternatively a spray-dried MAO. In other aspects the alkylaluminoxane may be a modified-methylaluminoxane (MMAO) such as a tri(isobutyl)aluminum-modified methylaluminoxane.

Aspect 7. The method of any one of aspects 1 to 6 wherein the effective catalyst is a spray-dried effective catalyst made by spray-drying a mixture of a hydrophobic fumed silica, activator, and the ligand-metal complex of formula (I) from an inert hydrocarbon solvent (e.g., toluene) so as to give the effective catalyst as a spray-dried supported catalyst. In some aspects the activator is an alkylaluminoxane, alternatively a methylaluminoxane (MAO). In some aspects the hydrophobic fumed silica is a dichlorodimethylsilane-treated fumed silica.

Aspect 8. The method of any one of aspects 1 to 7 wherein the method consists essentially of using the effective catalyst as the only catalyst in a single polymerization reactor under effective steady-state gas-phase or slurry-phase polymerization conditions and the contacting step consists essentially of contacting the ethylene and the at least one 1-alkene (comonomer(s)) with the effective catalyst as the only catalyst in the single polymerization reactor under the effective steady-state gas-phase or slurry-phase polymerization conditions so as to give the poly(ethylene-co-1-alkene) copolymer having a reverse comonomer distribution as a unimodal poly(ethylene-co-1-alkene) copolymer having a reverse comonomer distribution.

Aspect 9. The method of any one of aspects 1 to 7 wherein the method consists essentially of using the effective catalyst as the only catalyst in two different polymerization reactors, each polymerization reactor independently having a different set of effective gas-phase or slurry-phase polymerization conditions and making a different poly(ethylene-co-1-alkene) copolymer having a reverse comonomer distribution; and the contacting step consists essentially of contacting first amounts of ethylene and at least one 1-alkene (comonomer(s)) with the effective catalyst in a first polymerization reactor under a first set of effective gas-phase or slurry-phase polymerization conditions so as to make a first unimodal poly(ethylene-co-1-alkene) copolymer having a first reverse comonomer distribution; contacting second amounts of ethylene and at least one 1-alkene (comonomer(s)) with the same effective catalyst in a second polymerization reactor under a second set of effective gas-phase or slurry-phase polymerization conditions so as to make a second unimodal poly(ethylene-co-1-alkene) copolymer having a second reverse comonomer distribution, wherein the second set of effective gas-phase or slurry-phase polymerization conditions is different than the first set of effective gas-phase or slurry-phase polymerization conditions, respectively, and the second reverse comonomer distribution is different than the first reverse comonomer distribution; and combining the first and second unimodal poly(ethylene-co-1-alkene) copolymers so as to give the poly(ethylene-co-1-alkene) copolymer having a reverse comonomer distribution as a bimodal poly(ethylene-co-1-alkene) copolymer having a combined reverse comonomer distribution (“first multimodal poly(ethylene-co-1-alkene) copolymer having a reverse comonomer distribution”). The combining step may be done in-situ in the second polymerization reactor or in a post-reactor operation such as in a melt-mixing operation. The in-situ embodiment of the combining step may be done by transferring the first unimodal poly(ethylene-co-1-alkene) copolymer having a first reverse comonomer distribution from the first polymerization reactor into the second polymerization reactor, and then performing the second contacting step in the presence of the first unimodal poly(ethylene-co-1-alkene) copolymer having a first reverse comonomer distribution in the second polymerization reactor. In such an in-situ embodiment, a fresh amount of the effective catalyst may not be fed into the second polymerization reactor; instead the second contacting step is catalyzed by the effective catalyst that has been fed into the first polymerization reactor and subsequently carried within the first unimodal poly(ethylene-co-1-alkene) copolymer having a first reverse comonomer distribution during its transfer from the first polymerization reactor into the second polymerization reactor.

Aspect 10. The method of any one of aspects 1 to 7 wherein the method consists essentially of using a multimodal catalyst system (two or more different catalysts) in a single polymerization reactor under effective steady-state gas-phase or slurry-phase polymerization conditions, wherein the multimodal catalyst system consists essentially of the effective catalyst described in any one of aspects 1 to 7 (“first effective catalyst”) and at least one different catalyst selected from at least one of a second effective catalyst made from a different ligand-metal complex of formula (I) than that used to make the first effective catalyst, a bis(biphenylphenoxy)-based catalyst made contacting a ligand-metal complex of formula (II) with the activator under the activating conditions, a metallocene catalyst, and a bis((alkyl-substituted phenylamido)ethyl)amine catalyst, alternatively selected from the second effective catalyst, alternatively selected from at least one of a metallocene catalyst and a bis((alkyl-substituted phenylamido)ethyl)amine catalyst; and wherein the contacting step consists essentially of contacting the ethylene and the at least one 1-alkene (comonomer(s)) with the multimodal catalyst system in the single polymerization reactor under the effective steady-state gas-phase or slurry-phase polymerization conditions so as to give the poly(ethylene-co-1-alkene) copolymer having a reverse comonomer distribution as a multimodal poly(ethylene-co-1-alkene) copolymer having a reverse comonomer distribution (“second multimodal poly(ethylene-co-1-alkene) copolymer having a reverse comonomer distribution”); wherein the ligand-metal complex of formula (II) is:

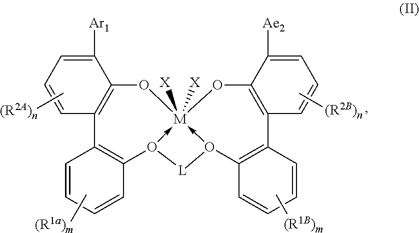

wherein each X independently is a halogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl; Z is a divalent alkylene linking group having two or more carbon atoms; M is Ti, Hf, or Zr; each of Ar¹ and Ar² independently is an unsubstituted or substituted phenyl group or an unsubstituted or N-substituted carbazolyl group; each subscript m is an integer from 0 to 4; each subscript n is an integer from 0 to 3; each of R^{1A} and R^{1B} independently is a halogen or a (C₁-C₆)alkyl; each of R^{2A} and R^{2B} independently is a halogen or a (C₁-C₈)alkyl; with the proviso that when each of Ar¹ and Ar² independently is the N-substituted carbazolyl group, formula (II) differs from formula (I) by at least one of the following differences (i) to (xi): (i) Z of formula (II) is not the same as L of formula (I), (ii) R^{1A} of formula (II) is not the same as R^{1a} of formula (I), (iii) R^{1B} of formula (II) is not the same as R^{1b} of formula (I), (iv) R^{2A} of formula (II) is not the same as R^{2a} of formula (I), (v) R^{2B} of formula (II) is not the same as R^{2b} of formula (I), (vi) both (i) and (ii), (vii) both (i) and (iii), (viii) both (i) and (iv), (ix) both (i) and (v), (x) any four of (i) to (v), and (xi) each of (i) to (v). In some aspects the multimodal catalyst system is a bimodal catalyst system consisting essentially of the effective catalyst described in any one of aspects 1 to 6 and the different catalyst is only the metallocene catalyst; and the second multimodal poly(ethylene-co-1-alkene) copolymer having a reverse comonomer distribution is a second bimodal poly(ethylene-co-1-alkene) copolymer having a reverse comonomer distribution. Alternatively, the multimodal catalyst system is a bimodal catalyst system consisting essentially of the effective catalyst described in any one of aspects 1 to 6 and the different catalyst is only the bis((alkyl-substituted phenylamido)ethyl)amine catalyst; and the second multimodal poly(ethylene-co-1-alkene) copolymer having a reverse comonomer distribution is a second bimodal poly(ethylene-co-1-alkene) copolymer having a reverse comonomer distribution. The first and second bimodal poly(ethylene-co-1-alkene) copolymers having a reverse comonomer distributions are different. A multimodal poly(ethylene-co-1-alkene) copolymer having a reverse comonomer distribution means at least one of the constituents thereof has reverse comonomer distribution and the remaining constituents independently have a normal, flat, or reverse comonomer distribution and the comonomer distribution overall is reverse. A bimodal poly(ethylene-co-1-alkene) copolymer having a reverse comonomer distribution means at least one of the constituents thereof has reverse comonomer distribution and the other constituent has a normal, flat, or reverse comonomer distribution. For example, the bimodal poly(ethylene-co-1-alkene) copolymer having a reverse comonomer distribution may consist essentially of a higher molecular weight (HMW) poly(ethylene-co-1-alkene) copolymer having a reverse comonomer distribution (and made by the effective catalyst) and a lower molecular weight (LMW) poly(ethylene-co-1-alkene) copolymer having a normal molecular weight distribution (e.g., and made by a metallocene catalyst). The effective catalyst is capable of making the HMW poly(ethylene-co-1-alkene) copolymer having a reverse comonomer distribution due to its greater ability to build molecular weight and its response to H₂ relative to those of a metallocene catalyst. In some aspects each of the HMW and LMW constituents have a unimodal molecular weight distribution.

Aspect 11. The method of any one of aspects 1 to 10 further comprising a step of making the effective catalyst by contacting the ligand-metal complex of formula (I) with the activator under the effective activating conditions to give the effective catalyst. The activator may be an alkylaluminoxane. The alkylaluminoxane may be any one of the alkylaluminoxanes described later or a combination of any two or more thereof. In some aspects the alkylaluminoxane is a methylaluminoxane (MAO), alternatively a spray-dried MAO.

Aspect 12. The method of any one of aspects 1 to 11, the method further comprising adding a trim catalyst into a gas-phase or slurry-phase polymerization reactor, wherein the trim catalyst consists essentially of a solution of the effective catalyst in unsupported form dissolved in an inert hydrocarbon solvent. The inert hydrocarbon liquid consists essentially of, alternatively consists of compounds consisting of carbon and hydrogen atoms and free of carbon-carbon double and carbon-carbon triple bonds. Examples of the inert hydrocarbon liquid are toluene, xylene(s), alkanes, mixture of isopentane and hexane(s), isopentane, decane, and mineral oil. Alternatively, the method may comprise adding the trim catalyst to a support material having an activator and at least one different catalyst (e.g., metallocene catalyst) to make the multimodal catalyst system in situ. The effective catalyst advantageously is expected to have sufficient solubility in the inert hydrocarbon solvent so as to be used as a trim catalyst.

Aspect 13. Use of the effective catalyst described in any one of aspects 1 to 7 for making a poly(ethylene-co-1-alkene) copolymer having a reverse comonomer distribution.

Aspect 14. A spray-dried, supported effective catalyst made by spray-drying a mixture of a hydrophobic fumed silica, activator, and the ligand-metal complex of formula (I) as described in any one of aspects 1 to 6 from an inert hydrocarbon solvent (e.g., toluene) so as to give the effective catalyst as a spray-dried supported effective catalyst. In some aspects the ligand-metal complex of formula (I) is Complex (1) or Complex (2). In some aspects the activator is an alkylaluminoxane, alternatively a methylaluminoxane (MAO). In some aspects the hydrophobic fumed silica is a dichlorodimethylsilane-treated fumed silica.

Aspect 15. A poly(ethylene-co-1-alkene) copolymer having a reverse comonomer distribution made by the method of any one of aspects 1 to 12. In some aspects the poly(ethylene-co-1-alkene) copolymer having a reverse comonomer distribution has a unimodal molecular weight distribution (unimodal MWD) or a bimodal molecular weight distribution (bimodal MWD), alternatively a unimodal MWD, alternatively a bimodal MWD. In some aspects the poly(ethylene-co-1-alkene) copolymer having a reverse comonomer distribution has a trimodal MWD, alternatively a tetramodal MWD; wherein the trimodal or tetramodal MWD are made using three or four, respectively, polymerization reactors in series, at least one of which is a gas-phase or slurry-phase polymerization reactor and the remainder independently are gas-phase, solution-phase, or slurry-phase polymerization reactors.

In some embodiments of any one of aspects 1 to 15, the method is run under effective steady-state gas-phase polymerization conditions in a gas-phase polymerization reactor. In other embodiments of any one of aspects 1 to 15, the method is run under effective steady-state slurry-phase polymerization conditions in a slurry-phase polymerization reactor. The “steady-state” means result effective variables are kept substantially constant or substantially unchanged.

Herein “consisting essentially of” and “consists essentially of” mean being free of any catalyst that is not made from the ligand-metal complex of formula (I).

Ligand-metal complex of formula (I). Complexes of formula (I) wherein L is CH₂CH₂CH₂ may be synthesized by the general methods illustrated in FIGS. 1 to 4 of, as described in, U.S. Pat. No. 9,029,487 B2.

Complex (1). The complex (1) has the following structure:

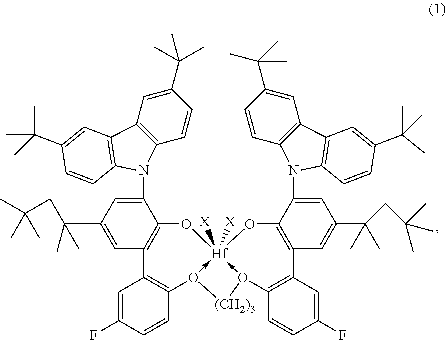

wherein each X independently is a halogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl. In some embodiments each X of complex (1) may be methyl or benzyl, alternatively methyl.

The complex (1) wherein each X is methyl may be synthesized according to the procedure described for Example 1 of U.S. Pat. No. 9,029,487 B2. Complex (1) wherein each X is methyl is named (2′,2″-(propane-1,3-diylbis(oxy))bis(3-(3,6-di-tert-butyl-9H-carbazol-9-yl)-5′-fluoro-5-(2,4,4-trimethylpentan-2yl)biphenyl-2-ol)dimethyl-hafnium or (2′,2″-(propane-1,3-diylbis(oxy))bis(3-(3,6-di-tert-butyl-9H-carbazol-9-yl)-5′-fluoro-5-(2,4,4-trimethylpentan-2yl)biphenyl-2-ol)-hafnium dimethyl. Complex (1) wherein X is a (C₂-C₂₀)alkyl, a (C₇-C₂₀)aralkyl, a (C₁-C₆)alkyl-substituted (C₆-C₁₂)aryl, or a (C₁-C₆)alkyl-substituted benzyl may be synthesized according to the procedure described for Example 1 of U.S. Pat. No. 9,029,487 B2 except wherein methylmagnesium bromide (CH₃MgBr) is replaced by a (C₂-C₂₀)alkylMgBr, a (C₇-C₂₀)aralkylMgBr, a (C₁-C₆)alkyl-substituted (C₆-C₁₂)arylMgBr, or a (C₁-C₆)alkyl-substituted benzylMgBr. Complex (1) wherein X is Cl may be synthesized according to the procedure described for Example 1 of U.S. Pat. No. 9,029,487 B2 except wherein methylmagnesium bromide (CH₃MgBr) is omitted. Complex (1) wherein X is F, Br, or I may be synthesized according to the procedure described for Example 1 of U.S. Pat. No. 9,029,487 B2 except wherein HfCl₄ is replaced with HfF₄, HfBr₄, or Hfl₄, respectively.

Complex (2). The complex (2) has the following structure:

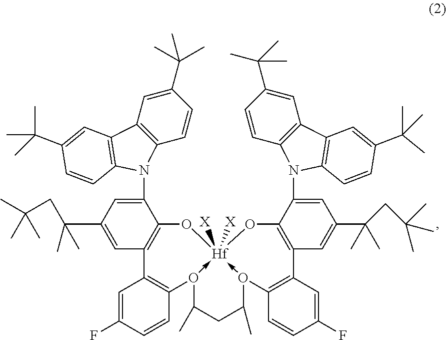

wherein each X independently is a halogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl. In some embodiments each X of complex (2) may be methyl or benzyl, alternatively methyl. The complex (2) may be synthesized in a manner analogous to the synthesis of complex (1).

Effective catalyst. The effective catalyst is made or activated by contacting the ligand-metal complex of formula (I) with the activator. Any activator may be the same or different as another and independently may be a Lewis acid, a non-coordinating ionic activator, or an ionizing activator, or a Lewis base, an alkylaluminum, or an alkylaluminoxane (alkylalumoxane). The alkylaluminum may be a trialkylaluminum, alkylaluminum halide, or alkylaluminum alkoxide (diethylaluminum ethoxide). The trialkylaluminum may be trimethylaluminum, triethylaluminum (“TEAl”), tripropylaluminum, or tris(2-methylpropyl)aluminum. The alkylaluminum halide may be diethylaluminum chloride. The alkylaluminum alkoxide may be diethylaluminum ethoxide. The alkylaluminoxane may be a methylaluminoxane (MAO), ethylaluminoxane, 2-methylpropyl-aluminoxane, or a modified methylaluminoxane (MMAO). Each alkyl of the alkylaluminum or alkylaluminoxane independently may be a (C₁-C₂₀)alkyl, alternatively a (C₁-C₇)alkyl, alternatively a (C₁-C₆)alkyl, alternatively a (C₁-C₄)alkyl. The molar ratio of activator's metal (Al) to a particular catalyst compound's metal (catalytic metal, e.g., Hf) may be 10000:1, alternatively 5000:1, alternatively 2000:1, alternatively 1000:1 to 0.5:1, alternatively 300:1 to 1:1, alternatively 150:1 to 1:1. Suitable activators are commercially available.

Once the activator and the ligand-metal complex of formula (I) contact each other, the effective catalyst (e.g., supported catalyst) is activated and activator species may be made in situ. The activator species may have a different structure or composition than the ligand-metal complex of formula (I) and activator from which it is derived and may be a by-product of the activation of the ligand-metal complex of formula (I) or may be a derivative of the by-product. The corresponding activator species may be a derivative of the Lewis acid, non-coordinating ionic activator, ionizing activator, Lewis base, alkylaluminum, or alkylaluminoxane, respectively. An example of the derivative of the by-product is a methylaluminoxane species that is formed by devolatilizing during spray-drying of a bimodal catalyst system made with methylaluminoxane.

The step of contacting step activator and ligand-metal complex of formula (I) may be done in a vessel outside the GPP reactor (e.g., outside the FB-GPP reactor) or in a feed line to the GPP reactor. In the former way the resulting effective catalyst may be fed from the separate vessel into the GPP reactor as a slurry or solution in a non-polar, aprotic (hydrocarbon) solvent, or may be dried and fed into the GPP reactor as a dry powder. The activator(s) may be fed into the GPP reactor in “wet mode” in the form of a solution thereof in an inert liquid such as mineral oil or toluene, in slurry mode as a suspension, or in dry mode as a powder.

In some aspects contacting the ligand-metal complex of formula (I) with at least one activator in situ in the GPP reactor in the presence of olefin monomer and comonomer (e.g., ethylene and 1-alkene) and growing polymer chains. These embodiments may be referred to herein as in situ-contacting embodiments. In other aspects the ligand-metal complex of formula (I) and the at least one activator are pre-mixed together for a period of time to make the effective catalyst, and then the effective catalyst is injected into the GPP reactor, where it contacts the olefin monomer and growing polymer chains. These latter embodiments pre-contact the ligand-metal complex of formula (I) and the at least one activator together in the absence of olefin monomer (e.g., in absence of ethylene and alpha-olefin) and growing polymer chains, i.e., in an inert environment, and are referred to herein as pre-contacting embodiments. The pre-mixing period of time of the pre-contacting embodiments may be from 1 second to 10 minutes, alternatively from 30 seconds to 5 minutes, alternatively from 30 seconds to 2 minutes.

The effective catalyst may be fed into the GPP reactor(s) in “dry mode” or “wet mode”, alternatively dry mode, alternatively wet mode. The dry mode is a dry powder or granules. The wet mode is a suspension in an inert liquid such as mineral oil or the (C₅-C₂₀)alkane(s).

Supported Catalyst. In some aspects the supported catalyst is made by pre-disposing the ligand-metal complex of formula (I) on the support material to give a pre-supported ligand-metal complex, and contacting the pre-supported ligand-metal complex with the activator so as to make the effective catalyst in-situ on the support material. In some aspects the pre-supported ligand-metal complex is spray-dried before being contacted with the activator, and the spray-dried complex is contacted with the activator, thereby forming a first supported catalyst. In other aspects the effective catalyst is made by contacting the ligand-metal complex of formula (I), the support material, and the activator together so as to make a second supported catalyst comprising, or consisting essentially of, the effective catalyst disposed in-situ on the support material. Typically, the contacting steps are performed with an inert hydrocarbon solvent. The inert hydrocarbon solvent is free of carbon-carbon double and triple bonds (i.e., non-aromatic). Examples are toluene, xylenes, isopentane, heptane, octane, decane, dodecane, mineral oil, paraffin oil, and a mixture of any two or more thereof. The first or second supported catalyst may be initially made as a suspension in the inert hydrocarbon solvent. In some aspects the suspension of the first or second supported catalyst is added directly into a polymerization reactor using a suspension catalyst feeder. In other aspects the first or second supported catalyst is spray-dried to give the first or second supported catalyst, respectively, in a dry powder form. The dry powder form of the first or second supported catalyst may be stored under an inert atmosphere (e.g., nitrogen and/or argon gas) or may be added as such directly into a polymerization reactor using a dry catalyst feeder. Suitable catalyst feeders are well-known in the art. If the dry powder form is stored, it later may be added directly as such to a polymerization reactor or may be suspended in fresh inert hydrocarbon solvent to form a fresh suspension thereof, which is then added to the polymerization reactor.

Support material. The support material may be an inorganic oxide material. The terms “support” and “support material” are the same as used herein and refer to a porous inorganic substance or organic substance. In some embodiments, desirable support materials may be inorganic oxides that include Group 2, 3, 4, 5, 13 or 14 oxides, alternatively Group 13 or 14 atoms. Examples of inorganic oxide-type support materials are silica, alumina, titania, zirconia, thoria, and mixtures of any two or more of such inorganic oxides. Examples of such mixtures are silica-chromium, silica-alumina, and silica-titania.

The inorganic oxide support material is porous and has variable surface area, pore volume, and average particle size. In some embodiments, the surface area is from 50 to 1000 square meter per gram (m²/g) and the average particle size is from 5 to 300 micrometers (μm), alternatively from 100 to 300 μm, alternatively from 8 to 99 μm, e.g., about 10 μm. Alternatively, the pore volume is from 0.5 to 6.0 cubic centimeters per gram (cm³/g) and the surface area is from 200 to 600 m²/g. Alternatively, the pore volume is from 1.1 to 1.8 cm³/g and the surface area is from 245 to 375 m²/g. Alternatively, the pore volume is from 2.4 to 3.7 cm³/g and the surface area is from 410 to 620 m²/g. Alternatively, the pore volume is from 0.9 to 1.4 cm³/g and the surface area is from 390 to 590 m²/g. Each of the above properties are measured using conventional techniques known in the art.

The support material may comprise silica, alternatively amorphous silica (not quartz), alternatively a high surface area amorphous silica (e.g., from 500 to 1000 m²/g). Such silicas are commercially available from several sources including the Davison Chemical Division of W.R. Grace and Company (e.g., Davison 952 and Davison 955 products), and PQ Corporation (e.g., ES70 product). The silica may be in the form of spherical particles, which are obtained by a spray-drying process. Alternatively, MS3050 product is a silica from PQ Corporation that is not spray-dried. As procured, these silicas are not calcined (i.e., not dehydrated). Silica that is calcined prior to purchase may also be used as the support material.

Prior to being contacted with a catalyst, the support material may be pre-treated by heating the support material in air to give a calcined support material. The pre-treating comprises heating the support material at a peak temperature from 350° to 850° C., alternatively from 400° to 800° C., alternatively from 400° to 700° C., alternatively from 500° to 650° C. and for a time period from 2 to 24 hours, alternatively from 4 to 16 hours, alternatively from 8 to 12 hours, alternatively from 1 to 4 hours, thereby making a calcined support material. The support material may be a calcined support material.

The support material may be a dehydrated untreated silica or a hydrophobic silica, which is made by contacting an untreated fumed silica with a hydrophobing agent. The pre-treatment allows the hydrophobing agent to react with surface hydroxyl groups on the untreated fumed silica, thereby modifying the surface chemistry of the fumed silica to give a hydrophobic fumed silica. The treated carrier material is made by treating an untreated carrier material with the hydrophobing agent. The treated carrier material may have different surface chemistry properties and/or dimensions than the untreated carrier material. The hydrophobing agent may be silicon based.

Fumed silica, untreated: pyrogenic silica produced in a flame. Consists of amorphous silica powder made by fusing microscopic droplets into branched, chainlike, three-dimensional secondary particles, which agglomerate into tertiary particles. Not quartz. The untreated fumed silica may be a porous and have variable surface area, pore volume, and average particle size. Each of the above properties are measured using conventional techniques known in the art. The untreated fumed silica may be amorphous silica (not quartz), such as a high surface area amorphous fumed silica (e.g., from 500 to 1000 m²/g). Such fumed silicas are commercially available from a number of sources. The fumed silica may be in the form of spherical particles, which are obtained by a spray-drying process. The untreated fumed silica may have been calcined (i.e., dehydrated) or not calcined.

Hydrophobing agent: an organic or organosilicon compound that forms a stable reaction product with surface hydroxyl groups of fumed silica.

Hydrophobing agent, silicon-based: an organosilicon compound that forms a stable reaction product with surface hydroxyl groups of a fumed silica. The organosilicon compound may be a polydiorganosiloxane compound or an organosilicon monomer, which contains silicon bonded leaving groups (e.g., Si-halogen, Si-acetoxy, Si-oximo (Si—ON═C<), Si-alkoxy, or Si-amino groups) that react with surface hydroxyl groups of untreated fumed silica to form Si—O—Si linkages with loss of water molecule as a by-product. The polydiorganosiloxane compound, such as a polydimethylsiloxane, contains backbone Si—O—Si groups wherein the oxygen atom can form a stable hydrogen bond to a surface hydroxyl group of fumed silica. The silicon-based hydrophobing agent may be trimethylsilyl chloride, dimethyldichlorosilane, a polydimethylsiloxane fluid, hexamethyldisilazane, an octyltrialkoxysilane (e.g., octyltrimethoxysilane), and a combination of any two or more thereof.

Trim catalyst. The method may further employ the effective catalyst as a trim catalyst. The trim catalyst may be any one of the aforementioned effective catalysts made from the metal-ligand complex of formula (I) and activator. For convenience the trim catalyst is fed in solution in a hydrocarbon solvent (e.g., mineral oil or heptane). The hydrocarbon solvent may be the ICA. The trim catalyst may be made from the same ligand-metal complex of formula (I) as that used to make the primary effective catalyst, alternatively the trim catalyst may be made from a different ligand-metal complex of formula (I). The trim catalyst may be used to vary, within limits, the amount of the effective catalyst used in the method. In some aspects the primary effective catalyst is a spray-dried effective catalyst made by spray-drying a mixture of the ligand-metal complex of formula (I), MAO, and a hydrophobic fumed silica in an inert hydrocarbon solvent (e.g., toluene); and the trim catalyst may be made from a separate amount of the same ligand-metal complex of formula (I) and a separate amount of MAO.

The bis(biphenylphenoxy)-based catalyst made by contacting the ligand-metal complex of formula (II) with the activator under the activating conditions. The ligand-metal complex of formula (II) is different than the ligand-metal complex of formula (I), i.e., there is no overlap between formula (II) and formula (I). That is, each embodiment of the ligand-metal complex of formula (II) does not satisfy description of the ligand-metal complex of formula (I), and vice versa each embodiment of the ligand-metal complex of formula (I) does not satisfy description of the ligand-metal complex of formula (II). Thus, the bis(biphenylphenoxy)-based catalyst made from the ligand-metal complex of formula (II) is structurally and functionally different than the effective catalyst made from the ligand-metal complex of formula (I). As described, the bis(biphenylphenoxy)-based catalyst made from the ligand-metal complex of formula (I) makes the inventive poly(ethylene-co-1-alkene) copolymer having a reverse comonomer distribution. It is believed, however, that the bis(biphenylphenoxy)-based catalyst made from the ligand-metal complex of formula (II) makes a poly(ethylene-co-1-alkene) copolymer having a normal comonomer distribution.

Gas-phase polymerization (GPP) reactor. Each gas phase polymerization (GPP) reactor used in the method independently may be a stirred-bed gas phase polymerization reactor (SB-GPP reactor) or a fluidized-bed gas phase polymerization (FB-GPP) reactor, alternatively a FB-GPP reactor. Such gas phase polymerization reactors and methods are generally well-known in the art. For example, the FB-GPP reactor/method may be as described in U.S. Pat. Nos. 3,709,853; 4,003,712; 4,011,382; 4,302,566; 4,543,399; 4,882,400; 5,352,749; 5,541,270; EP-A-0 802 202; and Belgian Patent No. 839,380. These SB-GPP and FB-GPP polymerization reactors and processes either mechanically agitate or fluidize by continuous flow of gaseous monomer and diluent the polymerization medium inside the reactor, respectively. Other useful reactors/processes contemplated include series or multistage polymerization processes such as described in U.S. Pat. Nos. 5,627,242; 5,665,818; 5,677,375; EP-A-0 794 200; EP-B1-0 649 992; EP-A-0 802 202; and EP-B-634421.

Embodiments of the method are illustrated herein using a FB-GPP reactor. Similar effective gas-phase polymerization conditions may be used in the SB-GPP reactor.

A pilot-scale FB-GPP reactor (Pilot Reactor) may be used in the method. The Pilot Reactor may comprise a reactor vessel containing a fluidized bed of a powder of a polyethylene polymer, and a distributor plate disposed above a bottom head, and defining a bottom gas inlet, and having an expanded section, or cyclone system, at the top of the reactor vessel to decrease amount of resin fines that may escape from the fluidized bed. The polyethylene powder may be composed of any polyethylene (co)polymer at startup of the Pilot Reactor. During steady-state operation of the Pilot Reactor the polyethylene powder may be the poly(ethylene-co-1-alkene) copolymer having a reverse comonomer distribution and a unimodal or multimodal molecular weight distribution. The expanded section defines a gas outlet. The reactor vessel may have a reaction zone dimensioned as 304.8 mm (twelve inch) internal diameter and a 2.4384 meter (8 feet) in straight-side height. The Pilot Reactor may have a recycle gas line for flowing a recycle gas stream. The Pilot Reactor may further comprise a compressor blower of sufficient power to continuously cycle or loop gas around from out of the gas outlet in the expanded section in the top of the reactor vessel down to and into the bottom gas inlet of the Pilot Reactor and through the distributor plate and fluidized bed. The Pilot Reactor may further comprise a cooling system to remove heat of polymerization and maintain the fluidized bed at a target temperature. Compositions of gases such as ethylene, 1-alkene (e.g., 1-hexene), and hydrogen being fed into the Pilot Reactor are monitored by an in-line gas chromatograph in the cycle loop in order to maintain specific concentrations thereof that define and enable control of polymer properties. The effective catalyst (e.g., the supported catalyst) may be fed as a slurry or dry powder into the Pilot Reactor from high pressure devices, wherein the slurry is fed via a syringe pump and the dry powder is fed via a metered disk. The effective catalyst typically enters the fluidized bed in the lower ⅓ of its bed height. The Pilot Reactor may further comprise a way of weighing the fluidized bed and isolation ports (Product Discharge System) for discharging a powder of the poly(ethylene-co-1-alkene) copolymer from the reactor vessel in response to an increase of the fluidized bed weight as polymerization reaction proceeds.

In some embodiments the FB-GPP reactor is a commercial scale reactor such as a UNIPOL™ reactor, which is available from Univation Technologies, LLC, a subsidiary of The Dow Chemical Company, Midland, Michigan, USA.

Effective gas-phase polymerization conditions. The method uses at least one set of effective gas-phase polymerization conditions. Each set of effective gas-phase polymerization conditions means steady-state conditions. The poly(ethylene-co-1-alkene) copolymer having a reverse comonomer distribution and a unimodal molecular weight distribution is made under the steady-state effective gas-phase polymerization conditions.

Each set of effective gas-phase polymerization conditions used in the GPP reactor independently may comprise temperature of the fluidized bed (“bed temperature”); partial pressure of ethylene (C₂) in the GPP reactor; a 1-alkene-to-ethylene (Cₓ/C₂) molar ratio of the feeds of 1-alkene and ethylene into the GPP reactor, wherein Cₓ indicates the 1-alkene; and, if hydrogen (H₂) is used, a hydrogen-to-ethylene (H₂/C₂) molar ratio of the feeds of hydrogen and ethylene into the FB-GPP reactor. If an induced condensing agent (ICA) is used in the GPP reactor, the set may further comprise the mole percent (mol %) of the ICA in the GPP reactor, based on total moles of ethylene, 1-alkene(s), and ICA in the GPP reactor. For 1-butene, the Cₓ/C₂ molar ratio is written as C₄/C₂ molar ratio; and for 1-hexene, the Cₓ/C₂ molar ratio is written as C₆/C₂ molar ratio. The set of effective gas-phase polymerization conditions may further comprise a concentration of an induced condensing agent (ICA) used in the GPP reactor, the superficial gas velocity in the GPP reactor, the total pressure in the GPP reactor, the catalyst productivity of the effective catalyst being used in the GPP reactor, the production rate of the copolymer being made in the GPP reactor, or an average residence time of the poly(ethylene-co-1-alkene) copolymer in the GPP reactor. The GPP reactor may be the FB-GPP reactor.

The temperature of the fluidized bed in the FB-GPP reactor may be from 70 to 110 degrees Celsius (° C.), alternatively from 75 to 104° C., alternatively from 80 to 100° C.

In some embodiments the partial pressure of C₂ in the FB-GPP reactor may be from 650 to 1800 kilopascals (kPa), alternatively from 680 to 1590 kPa, alternatively from 690 to 1520 kPa.

In some embodiments the (Cₓ/C₂) molar ratio may be from 0.0005 to 0.1, alternatively from 0.0009 to 0.05, alternatively from 0.01 to 0.02.

In some embodiments the (H₂/C₂) molar ratio may be 0 (when no H₂ is used), alternatively may be from 0.0001 to 2.0, alternatively from 0.0005 to 1.8, alternatively from 0.001 to 0.5, alternatively from 0.005 to 0.1, alternatively from 0.01 to 0.05, alternatively from 0.0001 to 0.1, alternatively from 0.0005 to 0.06, alternatively from 0.001 to 0.09.

In some embodiments the induced condensing agent (ICA) may comprise one or more (C₅-C₂₀)alkane(s), e.g., isopentane or a mixture of isopentane and at least one of isobutane, normal-pentane, normal-hexane, and isohexane. The concentration of ICA, when used, may be from 1 to 20 mol % based on total moles of ethylene, 1-alkene(s), and ICA in the reactor. The ICA mol % is measured by sampling effluent recirculating in a recycle loop or exhausting through a vent. The ICA may be fed separately into the GPP reactor and/or as part of a mixture also containing the effective catalyst (e.g., supported catalyst). The aspects of the polymerization method that use the ICA may be referred to as being an induced condensing mode operation (ICMO). ICMO is described in U.S. Pat. Nos. 4,453,399; 4,588,790; 4,994,534; 5,352,749; 5,462,999; and 6,489,408. The concentration of ICA in the reactor is measured indirectly as total concentration of vented ICA in recycle line using gas chromatography by calibrating peak area percent to mole percent (mol %) with a gas mixture standard of known concentrations of ad rem gas phase components.

In some embodiments the superficial gas velocity may be from 0.49 to 0.67 meter per second (m/sec) (1.6 to 2.2 feet per second (ft/sec)).

In some embodiments the total pressure in the FB-GPP reactor may be about 2344 to about 2413 kPa (about 340 to about 350 pounds per square inch-gauge (psig)).

In some embodiments the catalyst productivity is expressed as grams of copolymer made per gram of effective catalyst per hour (gPE/gcat/hour) and may be from 1,500 to 35,000 gPE/gcat/hour, alternatively from 1,800 to 32,000 gPE/gcat/hour. E.g., at pilot plant scale.

The production rate of copolymer being made may be measured as the rate the copolymer is being removed from the FB-GPP reactor under steady-state conditions and may be from 10 to 20 kilograms per hour (kg/hr), alternatively 13 to 18 kg/hr. E.g., at pilot plant scale.

In some embodiments the average residence times of the copolymer in the FB-GPP reactor may be from 1.5 to 5 hours, alternatively 2 to 4 hours.

The method may further comprise a step of transitioning from a first set of effective gas-phase polymerization conditions (first steady-state conditions) to a second set of effective gas-phase polymerization conditions (second steady-state conditions). The transitioning may be continuous or stepwise. Each of the first and second steady-state conditions may be used with a same effective catalyst. Same effective catalyst means an active compound that is made by contacting a same ligand-metal complex of formula (I), and if a support material is used from a same support material, with a same proportion of a same activator under same activating conditions so as to give the same effective catalyst with same composition and same catalytic activity. The first steady-state conditions may differ from the second steady-state conditions by at least one condition such as at least one of different bed temperatures, different C₂ partial pressures; different Cₓ/C₂ molar ratios; and, if hydrogen (H₂) is used, different H₂/C₂ molar ratios. Alternatively or additionally, in some embodiments the at least one condition may be different concentrations of an induced condensing agent (ICA) in the GPP reactor, different superficial gas velocities in the GPP reactor, different total pressures in the GPP reactor, or different average residence times of the poly(ethylene-co-1-alkene) copolymer in the GPP reactor. Each difference in first and second values for a given condition from the first steady-state condition to the second steady-state condition may be at least ±5%, alternatively at least ±10%, alternatively at least ±15%, alternatively at least ±25%. Such a difference in values may also be at most ±100%, alternatively at most ±50%. The first and second steady-state conditions may be used in two different polymerization reactors at the same or different times or in a same polymerization reactor at different times. The different first and second steady-state conditions may result in the method having different copolymer production rates and/or making different poly(ethylene-co-1-alkene) copolymer having different reverse comonomer distributions.

The effective gas-phase polymerization conditions may further include one or more additives such as a chain transfer agent or a promoter. The chain transfer agents are well known and may be alkyl metal such as diethyl zinc. Promoters are known such as in U.S. Pat. No. 4,988,783 and may include chloroform, CFCl₃, trichloroethane, and difluorotetrachloroethane. Prior to reactor start up, a scavenging agent may be used to react with moisture and during reactor transitions a scavenging agent may be used to react with excess activator. Scavenging agents may be a trialkylaluminum. Gas phase polymerizations may be operated free of (not deliberately added) scavenging agents. The effective gas-phase polymerization conditions for gas phase polymerization reactor/method may further include an amount (e.g., 0.5 to 200 ppm based on all feeds into reactor) of a static control agent and/or a continuity additive such as aluminum stearate or polyethyleneimine. The static control agent may be added to the GPP reactor to inhibit formation or buildup of static charge therein.

During the method individual flow rates of ethylene (“C₂”) and 1-alkene (“Cₓ”, e.g., 1-hexene or “C₆” or “Cₓ” wherein x is 6) may be controlled so as to maintain a fixed comonomer to ethylene monomer gas molar ratio (Cₓ/C₂, e.g., C₆/C₂) equal to a described value. Also, flow rate of any hydrogen (“H₂”) may be controlled to keep a constant H₂/C₂ molar ratio equal to a described value, and a constant ethylene (“C₂”) partial pressure equal to a described value. Concentrations of such gases may be measured by an in-line gas chromatograph to understand and maintain composition in a recycle gas stream in a recycle loop of an embodiment of the FB-GPP reactor having same. The reacting bed of growing polymer particles may be maintained in a fluidized state by continuously flowing a make-up feed and recycle gas through the reaction zone of the FB-GPP reactor. The superficial gas velocity and total pressure in the FB-GPP reactor may be controlled so as to maintain their described values. The fluidized bed in the FB-GPP reactor may be maintained at a constant height by withdrawing a portion of the bed at a rate equal to the rate of production of particulate form of the poly(ethylene-co-1-alkene) copolymer. Remove the produced poly(ethylene-co-1-alkene) copolymer semi-continuously via a series of valves into a fixed volume chamber, and purge the removed composition with a stream of humidified nitrogen (N₂) gas to remove entrained hydrocarbons and deactivate any quantities of residual catalysts.

In operating the method, control individual flow rates of ethylene (“C₂”), 1-alkene (“Cₓ”, e.g., 1-hexene or “C₆” or “Cₓ” wherein x is 6), and any hydrogen (“H₂”) to maintain a fixed comonomer to ethylene monomer gas molar ratio (Cₓ/C₂, e.g., C₆/C₂) equal to a described value, a constant hydrogen to ethylene gas molar ratio (“H₂/C₂”) equal to a described value, and a constant ethylene (“C₂”) partial pressure equal to a described value (e.g., 1,000 kPa). Measure concentrations of gases by an in-line gas chromatograph to understand and maintain composition in the recycle gas stream. Maintain a reacting bed of growing polymer particles in a fluidized state by continuously flowing a make-up feed and recycle gas through the reaction zone. Use a superficial gas velocity of 0.49 to 0.67 meter per second (m/sec) (1.6 to 2.2 feet per second (ft/sec)). Operate the FB-GPP reactor at a total pressure of about 2344 to about 2413 kilopascals (kPa) (about 340 to about 350 pounds per square inch-gauge (psig)) and at a described reactor bed temperature RBT. Maintain the fluidized bed at a constant height by withdrawing a portion of the bed at a rate equal to the rate of production of particulate form of the bimodal polyethylene polymer, which production rate may be from 10 to 20 kilograms per hour (kg/hr), alternatively 13 to 18 kg/hr. Remove the produced bimodal poly(ethylene-co-1-alkene) copolymer semi-continuously via a series of valves into a fixed volume chamber, and purge the removed composition with a stream of humidified nitrogen (N₂) gas to remove entrained hydrocarbons and deactivate any trace quantities of residual catalysts.

Slurry-phase polymerization reactor. Examples are mentioned in U.S. Pat. No. 10,344,101 B2 and batch and parallel pressure reactors described below.

Slurry-phase polymerization conditions. Examples are mentioned in U.S. Pat. No. 10,344,101 B2 and the conditions described below for the parallel pressure reactor.

Poly(ethylene-co-1-alkene) copolymer having a reverse comonomer distribution (MWCDI>0). A collection of macromolecules made by the method and having on average per molecule an ethylenic content of from 50 to <100 wt % and a comonomeric content (1-alkenic content) of from >0 to 50 wt % and an MWCDI>0.

1-Alkene(s) (comonomer(s)). The 1-alkene used with ethylene to make the poly(ethylene-co-1-alkene) copolymer may be propene, a (C₄-C₈)alpha-olefin, or a combination of any two or more of propene and (C₄-C₈)alpha-olefins; alternatively a (C₄-C₈)alpha-olefin; alternatively a combination of two or more (C₄-C₈)alpha-olefins. Each (C₄-C₈)alpha-olefin independently may be 1-butene, 1-pentene, 1-hexene, 4-methyl-1-pentene, 1-heptene, or 1-octene; alternatively 1-butene, 1-hexene, or 1-octene; alternatively 1-butene or 1-hexene; alternatively 1-hexene or 1-octene; alternatively 1-butene; alternatively 1-hexene; alternatively 1-octene; alternatively a combination of 1-butene and 1-hexene; alternatively a combination of 1-hexene and 1-octene. The 1-alkene may be 1-hexene and the poly(ethylene-co-1-alkene) copolymer may be a poly(ethylene-co-1-hexene) copolymer. Alternatively, the 1-alkene may be a combination of 1-hexene and propene, 1-butene, or 1-octene. When the 1-alkene is a combination of two different 1-alkenes, the poly(ethylene-co-1-alkene) copolymer is a poly(ethylene-co-1-alkene) terpolymer.

The poly(ethylene-co-1-alkene) copolymer having a reverse comonomer distribution and, optionally, the unimodal molecular weight distribution, is useful for making manufactured articles, and components thereof, comprising the poly(ethylene-co-1-alkene) copolymer or a blend thereof with a compatible polyethylene polymer made with a different catalyst than the effective catalyst. Examples of the manufactured articles are films, membranes, sheets, small-part articles (e.g., bottles, bottle caps, and food containers), and large-part articles (e.g., drums and pipes).

Any compound, composition, formulation, mixture, or product herein may be free of any one of the chemical elements selected from the group consisting of: H, Li, Be, B, C, N, O, F, Na, Mg, Al, Si, P, S, Cl, K, Ca, Sc, Ti, V, Cr, Mn, Fe, Co, Ni, Cu, Zn, Ga, Ge, As, Se, Br, Rb, Sr, Y, Zr, Nb, Mo, Tc, Ru, Rh, Pd, Ag, Cd, In, Sn, Sb, Te, I, Cs, Ba, Hf, Ta, W, Re, Os, Ir, Pt, Au, Hg, TI, Pb, Bi, lanthanoids, and actinoids; with the proviso that any required chemical elements (e.g., C and H required by a polyolefin; or Hf required by M=Hf) are not excluded.

Alternatively precedes a distinct embodiment. ASTM means the standards organization, ASTM International, West Conshohocken, Pennsylvania, USA. Any comparative example is used for illustration purposes only and shall not be prior art. Free of or lacks means a complete absence of; alternatively not detectable. ISO is International Organization for Standardization, Chemin de Blandonnet 8, CP 401-1214 Vernier, Geneva, Switzerland. IUPAC is International Union of Pure and Applied Chemistry (IUPAC Secretariat, Research Triangle Park, North Carolina, USA). May confers a permitted choice, not an imperative. Operative means functionally capable or effective. Optional(ly) means is absent (or excluded), alternatively is present (or included). PAS is Publicly Available Specification, Deutsches Institut für Normunng e.V. (DIN, German Institute for Standardization) Properties may be measured using standard test methods and conditions. Ranges include endpoints, subranges, and whole and/or fractional values subsumed therein, except a range of integers does not include fractional values. Room temperature: 23° C.±1° C.

Terms used herein have their IUPAC meanings unless defined otherwise. For example, see Compendium of Chemical Terminology. Gold Book, version 2.3.3, Feb. 24, 2014.

The relative terms “higher” and “lower” in HMW and LMW are used in reference to each other and merely mean that the weight-average molecular weight of the HMW component (M_{w-HMW}) is greater than the weight-average molecular weight of the LMW component (M_{w-LMW}), i.e., M_{w-HMW}>M_{w-LMW}.

Bimodal. A distribution having only two maxima. A bimodal molecular weight distribution may be characterized by two peaks in a plot of dW/d Log(MW) on the y-axis versus Log(MW) on the x-axis of a GPC chromatogram. The two peaks may be separated by a distinguishable local minimum therebetween or one peak may merely be a shoulder on the other, or both peaks may partly overlap so as to appear is a single GPC peak, which upon deconvolution may reveal both peaks.

Metallocene catalyst. Homogeneous or heterogeneous material that contains a cyclopentadienyl ligand-metal complex and enhances olefin polymerization reaction rates. Substantially single site or dual site. Each metal is a transition metal Ti, Zr, or Hf. Each cyclopentadienyl ligand independently is an unsubstituted cyclopentadienyl group or a hydrocarbyl-substituted cyclopentadienyl group. The metallocene catalyst may have two cyclopentadienyl ligands, and at least one, alternatively both cyclopentenyl ligands independently is a hydrocarbyl-substituted cyclopentadienyl group. Each hydrocarbyl-substituted cyclopentadienyl group may independently have 1, 2, 3, 4, or 5 hydrocarbyl substituents. Each hydrocarbyl substituent may independently be a (C₁-C₄)alkyl. Two or more substituents may be bonded together to form a divalent substituent, which with carbon atoms of the cyclopentadienyl group may form a ring.

Multimodal. A distribution having two or more maxima.

Single-site catalyst. An organic ligand-metal complex useful for enhancing rates of polymerization of olefin monomers and having at most two discreet binding sites at the metal available for coordination to an olefin monomer molecule prior to insertion on a propagating polymer chain.

Single-site non-metallocene catalyst. A substantially single-site or dual site, homogeneous or heterogeneous material that is free of an unsubstituted or substituted cyclopentadienyl ligand, but instead has one or more functional ligands such as bisphenyl phenol or carboxamide-containing ligands.

Unimodal. A distribution having only one maximum. A unimodal molecular weight distribution may be characterized as one peak in a plot of dW/d Log(MW) on the y-axis versus Log(MW) on the x-axis of a GPC chromatogram, wherein Log(MW) and dW/d Log(MW) are as defined herein and are measured by the GPC Test Method described later.

Ziegler-Natta catalysts. Heterogeneous materials that enhance olefin polymerization reaction rates and are prepared by contacting inorganic titanium compounds, such as titanium halides supported on a magnesium chloride support, with an activator.

### Examples

Carbon-13 Nuclear Magnetic Resonance (¹³C-NMR) Spectroscopy Test Method: Samples are prepared by adding approximately 3 grams (g) of a 50/50 mixture of tetra-chloroethane-d₂/1,2-dichlorobenzene, containing 0.025 M Cr(AcAc)₃, to a “0.25 g polymer sample” in a 10 millimeter (mm) NMR tube. Oxygen is removed from the sample by purging the tube headspace with nitrogen. The samples are then dissolved, and homogenized, by heating the tube and its contents to 150° C., using a heating block and heat gun. Each dissolved sample is visually inspected to ensure homogeneity. All data are collected using a Bruker 400 megahertz (MHz) spectrometer. The data is acquired using a 6 second pulse repetition delay, 90-degree flip angles, and inverse gated decoupling with a sample temperature of 120° C. All measurements are made on non-spinning samples in locked mode. Samples are allowed to thermally equilibrate for 7 minutes prior to data acquisition. The 13C NMR chemical shifts were internally referenced to the EEE triad at 30.0 parts per million (ppm). C₁₃ NMR Comonomer Content. ASTM D 5017-96; J. C. Randall et al., in “NMR and Macromolecules” ACS Symposium series 247; J. C. Randall, Ed., Am. Chem. Soc., Washington, D.C., 1984, Ch. 9; and J. C. Randall in “Polymer Sequence Determination”, Academic Press, New York (1977) provide general methods of polymer analysis by NMR spectroscopy.

Deconvoluting Test Method: Fit a GPC chromatogram of a bimodal polyethylene into a high molecular weight (HMW) component fraction and low molecular weight (LMW) component fraction using a Flory Distribution that was broadened with a normal distribution function as follows. For the log M axis, establish 501 equally-spaced Log(M) indices, spaced by 0.01, from Log(M) 2 and Log(M) 7, which range represents molecular weight from 100 to 10,000,000 grams per mole. Log is the logarithm function to the base 10. At any given Log(M), the population of the Flory distribution is in the form of the following equation:

$$d {W}_{f} = {( \frac{2}{{M}_{w}} )}^{3} ( \frac{{M}_{w}}{0.868588961964} ) {M}^{2} {e}^{( - 2 M / {M}_{w} )} ,$$

wherein M_{w} is the weight-average molecular weight of the Flory distribution; M is the specific x-axis molecular weight point, (10\hat{ }[Log(M)]); and dW_{f} is a weight fraction distribution of the population of the Flory distribution. Broaden the Flory distribution weight fraction, dW_{f}, at each 0.01 equally-spaced log(M) index according to a normal distribution function, of width expressed in Log(M), a; and current M index expressed as Log(M), μ.

$${f}_{( Log M , μ , σ )} = \frac{{e}^{- \frac{{( Log M - μ )}^{2}}{2 {σ}^{2}}}}{σ \sqrt{2 π}} .$$

Before and after the spreading function has been applied, the area of the distribution (dW_{f}/d Log M) as a function of Log(M) is normalized to 1. Express two weight-fraction distributions, dW_{f-HMW} and dW_{f-LMW}, for the HMW copolymer component fraction and the LMW copolymer component fraction, respectively, with two unique M_{w} target values, M_{w-HMW} and M_{w-LMW}, respectively, and with overall component compositions A_{HMW} and A_{LMW}, respectively. Both distributions were broadened with independent widths, σ (i.e., σ_{HMW}=σ_{LMW}, respectively). The two distributions were summed as follows: dW_{f}=A_{HMW}dW_{fHMW}+A_{LMW}dW_{fLMW}, wherein A_{HMW}+A_{LMW}=1. Interpolate the weight fraction result of the measured (from conventional GPC) GPC molecular weight distribution along the 501 log M indices using a 2^{nd}-order polynomial. Use Microsoft Excel™ 2010 Solver to minimize the sum of squares of residuals for the equally-spaces range of 501 Log M indices between the interpolated chromatographically determined molecular weight distribution and the three broadened Flory distribution components (σ_{HMW} and σ_{LMW}), weighted with their respective component compositions, A_{HMW} and A_{LMW}. The iteration starting values for the components are as follows: Component 1: Mw=30,000, σ=0.300, and A=0.500; and Component 2: Mw=250,000, σ=0.300, and A=0.500. The bounds for components σ_{HMW} and σ_{LMW} are constrained such that σ>0.001, yielding an M_{w}/Mₙ of approximately 2.00 and σ<0.500. The composition, A, is constrained between 0.000 and 1.000. The M_{w} is constrained between 2,500 and 2,000,000. Use the “GRG Nonlinear” engine in Excel Solver™ and set precision at 0.00001 and convergence at 0.0001. Obtain the solutions after convergence (in all cases shown, the solution converged within 60 iterations).

Density is measured according to ASTM D792-13, Standard Test Methods for Density and Specific Gravity (Relative Density) of Plastics by Displacement, Method B (for testing solid plastics in liquids other than water, e.g., in liquid 2-propanol). Report results in units of grams per cubic centimeter (g/cm³).

Gel permeation chromatography (GPC) Test Method: Use a PolymerChar GPC-IR (Valencia, Spain) high temperature GPC chromatograph equipped with an internal IR5 infra-red detector (IR5, measurement channel). Set temperatures of the autosampler oven compartment at 160° C. and column compartment at 150° C. Use a column set of four Agilent “Mixed A” 30 cm 20-micron linear mixed-bed columns; solvent is 1,2,4 trichlorobenzene (TCB) that contains 200 ppm of butylated hydroxytoluene (BHT) sparged with nitrogen. Injection volume is 200 microliters (μL). Set flow rate to 1.0 milliliter/minute. Calibrate the column set with at least 20 narrow molecular weight distribution polystyrene (PS) standards (Agilent Technologies) arranged in six “cocktail” mixtures with approximately a decade of separation between individual molecular weights with molecular weights ranging from 580 to 8,400,000 in each vial. Convert the PS standard peak molecular weights to polyethylene molecular weights using the method described in Williams and Ward, J. Polym. Sci., Polym. Let., 6, 621 (1968) and equation 1: (M_{polyethylene}=A×(M_{polystyrene})^{B} (EQ1), wherein M_{polyethylene} is molecular weight of polyethylene, M_{polystyrene} is molecular weight of polystyrene, A=0.4315, x indicates multiplication, and B=1.0; where MPE=MPS×Q, where Q ranges between 0.39 to 0.44 to correct for column resolution and band-broadening effects) based on a linear homopolymer polyethylene molecular weight standard of approximately 120,000 and a polydispersity of approximately 3, which is measured independently by light scattering for absolute molecular weight. Dissolve samples at 2 mg/mL in TCB solvent at 160° C. for 2 hours under low-speed shaking. Generate a baseline-subtracted infra-red (IR) chromatogram at each equally-spaced data collection point (i), and obtain polyethylene equivalent molecular weight from a narrow standard calibration curve for each point (i) from EQ1. Calculate number-average molecular weight (Mₙ or Mₙ_{^{(GPC)}}), weight-average molecular weight (M_{w} or M_{w}_{^{(GPC)}}), and z-average molecular weight (M_{z} or M_{z}_{^{(GPC)}}) based on GPC results using the internal IR5 detector (measurement channel) with PolymerChar GPCOne™ software and equations 2 to 4, respectively: equation 2:

$$\begin{matrix}equation 3 & \\ M n ( G P C ) = \frac{{\sum }^{i} I {R}_{i}}{{\sum }^{i} ( I {R}_{i} / {M}_{p o l y e t h y l e n {e}_{i}} )} ; & ( EQ2 )\end{matrix}$$

$$\begin{matrix}equation 4 & \\ M w ( G P C ) = \frac{{\sum }^{i} ( I {R}_{i} * {M}_{p o l y e t h y l e n {e}_{i}} )}{{\sum }^{i} I {R}_{i}} ; and & ( EQ3 )\end{matrix}$$

$$M z ( G P C ) = \frac{{\sum }^{i} ( I {R}_{i} * {M}_{p o l y e t h y l e n {e}_{i}^{2}} )}{{\sum }^{i} ( I {R}_{i} * {M}_{p o l y e t h y l e n {e}_{i}} )} . \qquad ( EQ4 )$$

Monitor effective flow rate over time using decane as a nominal flow rate marker during sample runs. Look for deviations from the nominal decane flow rate obtained during narrow standards calibration runs. If necessary, adjust the effective flow rate of decane so as to stay within ±2% of the nominal flow rate of decane as calculated according to equation 5: Flow rate(effective)=Flow rate(nominal)*(RV_{(FM Calculated)}/RV_{(FM Sample)} (EQ5), wherein Flow rate(effective) is the effective flow rate of decane, Flowrate(nominal) is the nominal flow rate of decane, RV_{(FM Calibrated)} is retention volume of flow rate marker decane calculated for column calibration run using narrow standards, RV_{(FM Sample)} is retention volume of flow rate marker decane calculated from sample run, * indicates mathematical multiplication, and/indicates mathematical division. Discard any molecular weight data from a sample run with a decane flow rate deviation more than ±2%.

Molecular weight comonomer distribution index (MWCDI). Using the GPC instrument also equipped with a Precision Detectors (Amherst, MA), 2-angle laser light scattering detector Model 2040, a calibration for the IR5 detector ratios was performed using at least ten ethylene-based polymer standards (polyethylene homopolymer and ethylene/octene copolymers; narrow molecular weight distribution and homogeneous comonomer distribution) of known short chain branching (SOB) frequency (measured by the ¹³C NMR Method, as discussed above), ranging from homopolymer (0 SB/1000 total 0) to approximately 50 SOB/1000 total C, where total C=carbons in backbone+carbons in branches. Each standard had a weight-average molecular weight from 36,000 g/mole to 126,000 g/mole, as determined by the GPC-LALS (LALS=laser-assisted light scattering) processing method described above. Each standard had a molecular weight distribution (Mw/Mn) from 2.0 to 2.5, as determined by the GPC-LALS processing method described above. Polymer properties for the SOB standards are shown in Table A.

TABLE A
SCB standards.

| Wt % | IR5 Area | SCB/1000 | | |
|---|---|---|---|---|
| Comonomer | ratio | Total C | M_{w} | M_{w}/Mₙ |
| 23.1 | 0.2411 | 28.9 | 37,300 | 2.22 |
| 14.0 | 0.2152 | 17.5 | 36,000 | 2.19 |
| 0.0 | 0.1809 | 0.0 | 38,400 | 2.20 |
| 35.9 | 0.2708 | 44.9 | 42,200 | 2.18 |
| 5.4 | 0.1959 | 6.8 | 37,400 | 2.16 |
| 8.6 | 0.2043 | 10.8 | 36,800 | 2.20 |
| 39.2 | 0.2770 | 49.0 | 125,600 | 2.22 |
| 1.1 | 0.1810 | 1.4 | 107,000 | 2.09 |
| 14.3 | 0.2161 | 17.9 | 103,600 | 2.20 |
| 9.4 | 0.2031 | 11.8 | 103,200 | 2.26 |

For MWCDI, the “IRS Area Ratio (or IR5_{(Methyl Channel Area)}/IR5_{(Measurement Channel Area)}) of “the baseline-subtracted area response of the IR5 methyl channel sensor” to “the baseline-subtracted area response of IR5 measurement channel sensor” (standard filters and filter wheel as supplied by PolymerChar: Part Number IR5_FWM01 included as part of the GPC-IR instrument) was calculated for each of the “SCB” standards. A linear fit of the SCB frequency versus the “IR5 Area Ratio” was constructed in the form of the following Equation 4B: SCB/1000 total C=A₀+[A₁×IR5_{(Methyl Channel Area)}/IR5_{(Measurement Channel Area)}] (Eqn. 4B), where A₀ is the “SCB/1000 total C” intercept at an “IR5 Area Ratio” of zero, and A, is the slope of the “SCB/1000 total C” versus “IR5 Area Ratio,” and represents the increase in the “SCB/1000 total C” as a function of “IR5 Area Ratio.”

For MWCDI, a series of “linear baseline-subtracted chromatographic heights” for the chromatogram generated by the “IR5 methyl channel sensor” was established as a function of column elution volume, to generate a baseline-corrected chromatogram (methyl channel). A series of “linear baseline-subtracted chromatographic heights” for the chromatogram generated by the “IR5 measurement channel” was established as a function of column elution volume, to generate a base-line-corrected chromatogram (measurement channel).

For MWCDI, the “IR5 Height Ratio” of “the baseline-corrected chromatogram (methyl channel)” to “the baseline-corrected chromatogram (measurement channel)” was calculated at each column elution volume index (each equally-spaced index, representing 1 data point per second at 1 ml/min elution) across the sample integration bounds. The “IR5 Height Ratio” was multiplied by the coefficient A₁, and the coefficient A₀ was added to this result, to produce the predicted SCB frequency of the sample. The result was converted into mole percent comonomer, as follows in Equation 5B: Mole Percent Comonomer={SCB_{f}/[SCB_{f}+((1000−SCB_{f}*Length of comonomer)/2)]}*100 (Eqn. 5B), where “SCB_{f}” is the “SCB per 1000 total C”, also written as “SCB/1000TC” in Tables below, and the “Length of comonomer”=8 for octene, 6 for hexene, and so forth.

For MWCDI, each elution volume index was converted to a molecular weight value (Mwᵢ) using the method of Williams and Ward (described above; Eqn. 1 B). The “Weight Percent Comonomer (y axis)” was plotted as a function of Log(Mwᵢ), and the slope was calculated between Mwᵢ of 15,000 and Mwᵢ of 10,000,000 g/mole (e.g., 257,000 to 9,550,000 g/mol) (end group corrections on chain ends were omitted for this calculation). A Microsoft EXCEL linear regression was used to calculate the slope between, and including, Mwᵢ from 15,000 to 150,000 g/mole. This slope is defined as the molecular weighted comonomer distribution index (MWCDI=Molecular Weighted Comonomer Distribution Index).

Representative determination of MWCDI: A plot of the measured “SCB per 1000 total C (=SCB_{f})” versus the observed “IR5 Area Ratio” of the SCB standards was generated, and the intercept (A₀) and slope (A₁) were determined to be A₀=−90.246 SCB/1000 total C; and A₁=499.32 SCB/1000 total C. The “IR5 Height Ratio” was determined, and multiplied by the coefficient A₁. The coefficient A₀ was added to the result to produce the predicted SCB frequency (SCB_{f}) of the example, at each elution volume index, as described above (A₀=−90.246 SCB/1000 total C; and A₁=499.32 SCB/1000 total C). The SCB_{f} was plotted as a function of polyethylene-equivalent molecular weight, as determined using Equation 1. The SCB_{f} was converted into “Mole Percent Comonomer” via Equation 5B. The “Mole Percent Comonomer” was plotted as a function of polyethylene-equivalent molecular weight, as determined using Equation 1 B. A linear fit was from Mwᵢ of 15,000 g/mole to Mwᵢ of 150,000 g/mole, yielding a slope of “2.27 mole percent comonomer×mole/g.” Thus, the MWCDI=2.27. An EXCEL linear regression was used to calculate the slope between, and including, Mwᵢ from 15,000 to 150,000 g/mole.

Cabosil TS-610: a hydrophobic fumed silica made by contacting an untreated fumed silica with a hydrophobing agent that is dichlorodimethylsilane.
1-Alkene Comonomer: 1-hexene: H₂C═C(H)(CH₂)₃CH₃.
Ethylene (“C₂” or ethene): CH₂═CH₂.
ICA: a mixture consisting essentially of at least 95%, alternatively at least 98% of 2-methylbutane (isopentane) and minor constituents that at least include pentane (CH₃(CH₂)₃CH₃).
Molecular hydrogen gas: H₂.

Preparation 1: making Spray-Dried effective catalyst 1 (sd-Cat1) make from Complex (1), wherein each X is methyl, and a support material: In a nitrogen-purged glovebox, slurry 1.325 g Cabosil TS-610 hydrophobic fumed silica in 37.5 g toluene until well dispersed. Then add 11 g of a 10 wt % solution of MAO in toluene. Stir the mixture for 15 minutes. Then add 0.161 g of Complex (1). Stir the mixture for 30 to 60 minutes. Spray-dry the mixture using a Büchi Mini Spray Dryer B-290 with the following operating parameters: set temperature 185° C., outlet temperature 100° C., aspirator 95, and pump speed 150 rotations per minute (rpm) to give sd-Cat2.

Preparation 2: making concentrate-dried effective catalyst 1 (cd-Cat1) make from Complex (1), wherein each X is methyl, and a support material: Concentrate-dried means removing diluent from a container containing a stirred slurry of catalyst 1 in the diluent wherein the container is under vacuum and the slurry becomes increasingly concentrated as more and more diluent is removed. Charge a clean reactor at 27° to 30° C. with 1547 g of a 10 wt % solution of MAO in toluene. Stir at slow speed. Add 400 g of Davison 955-600 silica to the MAO solution. Stir resulting slurry for 30 minutes. Then add 550 g of Complex (1) to reactor. Stir resulting mixture for another 30 minutes. Then begin drying slowly under reduced pressure until full vacuum is reached. Then start a sweep of nitrogen gas to purge the reactor. Continue drying until temperature of the reactor contents has been unchanged for 2 hours to give cd-Cat1. Loading is 4.5 millimoles (mmol) of Al atom per gram of the silica and 45 micromoles (μm) of Hf atom per gram of the silica.

Preparation 3 (prophetic): making Spray-Dried effective catalyst 2 (sd-Cat2) made from Complex (2), wherein each X is methyl, and a support material: In a nitrogen-purged glovebox, slurry 1.325 g Cabosil TS-610 hydrophobic fumed silica in 37.5 g toluene until well dispersed. Then add 11 g of a 10 wt % solution of MAO in toluene. Stir the mixture for 15 minutes. Then add 0.164 g of Complex (2). Stir the mixture for 30 to 60 minutes. Spray-dry the mixture using a Büchi Mini Spray Dryer B-290 with the following operating parameters: set temperature 185° C., outlet temperature 100° C., aspirator 95, and pump speed 150 rotations per minute (rpm) to give sd-Cat2.

Gas-Phase Polymerization Batch Reactor polymerization procedure used for Examples 1 to 11: Use a 2-liter, stainless steel autoclave GPP reactor equipped with a mechanical agitator for each experimental run. Dry the reactor for 1 hour. Then charge the reactor with 200 g of NaCl, and dry by heating it at 100° C. under nitrogen for 30 minutes. Then add 3 g of spray-dried methylalumoxane to scavenge any remaining moisture under nitrogen pressure. Then seal the reactor. With stirring, charge the reactor with hydrogen and 1-hexene pressurized with ethylene. When the system reaches a steady state, charge effective catalyst sd-Cat1 or cd-Cat1 to the reactor at 80° C. to start polymerization. Bring the reactor temperature to a desired reaction temperature, and maintain it at this temperature for 1 hour. After 1 hour, cool the reactor and contents down, vent the cooled reactor. Wash the resulting poly(ethylene-co-T-alkene) copolymer product with water and methanol, then dry. Determine polymerization Activity (grams polymer/gram catalyst-hour) as the ratio of copolymer produced to the amount of effective catalyst added to the reactor. See Table 1 for batch reactor conditions for Examples 1 to 9 made with spray-dried catalyst sd-Cat1. See Table 2 for batch reactor conditions for Examples 10 and 11 made with conventionally-supported catalyst cd-Cat1. Copol. means poly(ethylene-co-1-alkene) copolymer.

TABLE 1
Batch Gas-Phase Reactor Conditions for sd-Cat1.

| | | C₆/C₂ | H₂/C₂ | C₂ partial | Catalyst | | Cat. |
|---|---|---|---|---|---|---|---|
| Ex | Temp. | molar | molar | press. | charge | Copol. | Product. |
| No. | (° C.) | ratio | ratio | (Kpa) | (mg) | Yield (g) | (gPE/gcat/hr) |
| 1 | 100 | 0.002 | 0.0016 | 1590 | 10.3 | 41.4 | 4019 |
| 2 | 100 | 0.002 | 0.01 | 1590 | 10.5 | 24.59 | 2342 |
| 3 | 100 | 0.002 | 0.05 | 1590 | 10.5 | 17.2 | 1638 |
| 4 | 100 | 0.002 | 0.1 | 1590 | 10.2 | 21.8 | 2137 |
| 5 | 80 | 0.001 | 0.0016 | 690 | 10.4 | 26.39 | 2538 |
| 6 | 100 | 0.001 | 0.0016 | 1590 | 10.1 | 48.17 | 4770 |
| 7 | 100 | 0.001 | 0.0068 | 1590 | 10.1 | 33.6 | 3327 |
| 8 | 100 | 0.001 | 0.01 | 1590 | 10.2 | 37.6 | 3686 |
| 9 | 90 | 0.004 | 0.0068 | 1590 | 10.5 | 25.6 | 2438 |

TABLE 2
Batch Gas-Phase Reactor Conditions for cd-Cat1.

| | | C₆/C₂ | H₂/C₂ | C₂ partial | Catalyst | | Cat. |
|---|---|---|---|---|---|---|---|
| Ex | Temp. | molar | molar | press. | charge | Copol. | Product. |
| No. | (° C.) | ratio | ratio | (Kpa) | (mg) | Yield (g) | (gPE/gcat/hr) |
| 10 | 80 | 0.005 | 0.004 | 1590 | 59.7 | 66.19 | 1109 |
| 11 | 100 | 0.005 | 0.004 | 1590 | 59.5 | 145.6 | 2447 |

Tables 1 and 2 describe batch gas phase reactor polymerization conditions and results for Examples 1 to 9 and for Examples 10 and 11, respectively.

As shown in Tables 3 to 4 below for Examples 1 to 9 and Examples 10 and 11, respectively, each of spray-dried catalyst sd-Cat1 and conventionally supported catalyst cd-Cat1, respectively, makes copolymers with reverse comonomer distributions (reverse SCBD) under a range of gas phase polymerization conditions. Properties of the poly(ethylene-co-1-alkene) copolymer made in Examples 1 to 9 with spray-dried catalyst sd-Cat1 in gas phase polymerization batch reactor are shown below in Table 3.

TABLE 3
properties of poly(ethylene-co-1-alkene) copolymers made with sd-
Cat1 in gas phase polymerization batch reactor.

| Ex | Mn | Mw | | Wt % | SCB/ | |
|---|---|---|---|---|---|---|
| No. | (g/mol) | (g/mol) | M_{w}/Mₙ | C₆ | 1000TC | MWCDI |
| 1 | 567,982 | 2,065,052 | 3.64 | 5.02 | 8.37 | 1.20 |
| 2 | 208,268 | 635,764 | 3.05 | 4.19 | 6.99 | 1.31 |
| 3 | 74,799 | 236,358 | 3.16 | 3.7 | 6.17 | 0.38 |
| 4 | 35,114 | 102,111 | 2.91 | 4.75 | 7.92 | 0.55 |
| 5 | 528,994 | 1,436,358 | 2.72 | 2.86 | 4.76 | 0.74 |
| 6 | 586,847 | 1,724,119 | 2.94 | 2.3 | 3.83 | 1.59 |
| 7 | 291,327 | 778,937 | 2.67 | 2.36 | 3.93 | 0.85 |
| 8 | 198,699 | 631,916 | 3.18 | 1.85 | 3.08 | 0.99 |
| 9 | 296,915 | 694,880 | 2.34 | 10.72 | 13.36 | 1.28 |

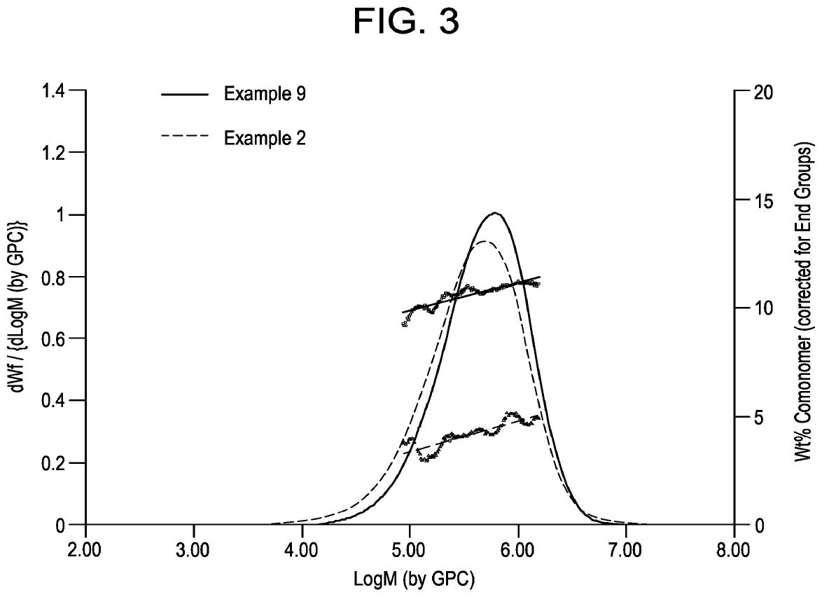

As shown in Table 3, each of the poly(ethylene-co-1-alkene) copolymers of Examples 1 to 9 made with spray-dried catalyst sd-Cat1 in gas phase polymerization batch reactor independently has a reverse comonomer distribution and a unimodal molecular weight distribution. The reverse comonomer distributions (sloped lines) and molecular weight distributions (bell-shaped curves) of inventive Examples 1 and 8 are graphically depicted in FIG. 2. The reverse comonomer distributions (sloped lines) and molecular weight distributions (bell-shaped curves) of inventive Examples 2 and 9 are graphically depicted in FIG. 3.

Properties of the poly(ethylene-co-1-alkene) copolymers of Examples 10 and 11 made with conventionally-supported catalyst cd-Cat1 in gas phase polymerization batch reactor are shown below in Table 4.

TABLE 4
properties of poly(ethylene-co-1-alkene) copolymers made
with cd-Cat1 in gas phase polymerization batch reactor.

| Ex | Mn | Mw | | Wt % | SCB/ | |
|---|---|---|---|---|---|---|
| No. | (g/mol) | (g/mol) | M_{w}/Mₙ | C₆ | 1000TC | MWCDI |
| 10 | 213,142 | 892,264 | 4.19 | 8.9 | 14.90 | 3.17 |
| 11 | 286,179 | 955,163 | 3.34 | 7.7 | 12.86 | 1.69 |

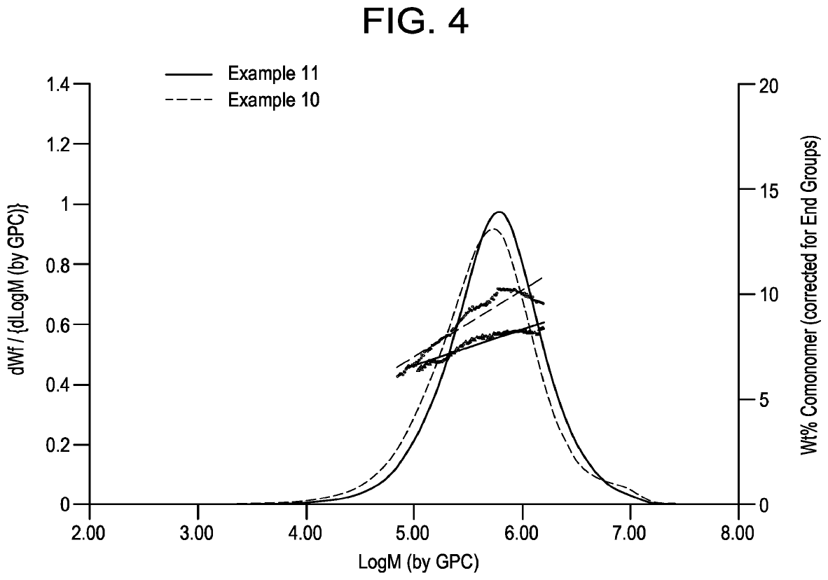

As shown in Table 4, each of the poly(ethylene-co-1-alkene) copolymers of Examples 10 and 11 made with conventionally-supported catalyst cd-Cat1 in gas phase polymerization batch reactor independently has a reverse comonomer distribution and a unimodal molecular weight distribution. The reverse comonomer distributions (sloped lines) and molecular weight distributions (bell-shaped curves) of inventive Examples 10 and 11 are graphically depicted in FIG. 4.

General procedure for slurry-phase polymerizations using conventionally supported catalyst (e.g., cd-Cat1) in a parallel pressure reactor (PPR) used for Examples 12 to 15. The PPR contains 48 glass vials (slurry-phase reactors) in reactor wells and a module body containing 48 module heads adapted to contain a stirrer paddle and seal one of the vials. Prepare all solutions in an inert atmosphere glove box under nitrogen. Purify Isopar E, ethylene, and hydrogen by passage of same through 2 columns, the first containing A2 alumina and the second containing Q5 reactant. Prepare ligand-metal complex stock solutions to known concentrations in toluene. To each reaction vial, add a desired amount of silica-supported MAO (SMAO, silica is the Cabosil TS-610) weighed to reach 45 micromoles (μmol) ligand-metal complex per 1 g SMAO (about 1:108 wt/wt equivalent ratio). Add a tumble stir disc. Dispense toluene into each vial, followed by desired amounts of one of the ligand-metal complex stock solutions. Cap the vials, and stir contents at 300 rotations per minute (rpm) while heating to 50° C. After 30 minutes, cool the vials and contents to room temperature, remove caps, and mix contents by vortexing at 800 rpm for 3 minutes, thereby making a homogeneous supported catalyst slurry. Daughter a desired amount of each supported catalyst slurry into 8 mL-volume vials, and dilute contents with Isopar E. Daughter reaction mixtures to desired concentrations in the PPRA day before to the polymerization runs, weigh and insert the 48 glass vials into the reactor wells. Attach stirrer paddles to the module heads. Attach the module heads to the module body. Heat the vials to 150° C., purge vials with nitrogen for 10 hours, and cool to 50° C. On the day of the polymerization run, purge the vials twice with ethylene and vent completely to purge lines. Then heat the vials to 50° C. and rotate the stirrer paddles at 400 rpm. Underfill the vials with Isopar-E. Heat the vials to final desired polymerization temperature. Increase stirring rpm. After 10 to 30 minutes, depending proportionally on the desired temperature, pressure the vials to the desired set point with either pure ethylene or a mixture of ethylene and hydrogen from a gas accumulator to saturate the solvent as evidenced by observing gas uptake. If the ethylene-hydrogen mixture is used, once the solvent is saturated in all cells, switch the gas feed line from the ethylene-hydrogen mixture to pure ethylene for the remainder of the run. Fill the vials to an appropriate solvent level (e.g., one third full) with Isopar-E to give a final reaction volume of 5 mL. Heat the reactors to final desired polymerization temperature. Increase stirring to desired set points. After 10 to 30 minutes, depending on the desired temperature, pressure the cells to the desired set point with either pure ethylene or a mixture of ethylene and hydrogen from a gas accumulator to saturate the solvent as evidenced by observing gas uptake. If an ethylene-hydrogen mixture is used, once the solvent is saturated in all cells, switch the gas feed line from the ethylene-hydrogen mixture to pure ethylene for the remainder of the run. Then inject comonomer solution (1-hexene) into the reactors, then inject a solution of SMAO in toluene, and finally inject the catalyst solution in Isopar-E. Chase each injection with 500 μL of Isopar-E solvent to ensure complete injection of the relevant reagent. At the moment of the catalyst injection, start a reaction timer. Allow slurry-phase polymerization reactions to proceed for 60 to 180 minutes or to the set ethylene uptake of from 0.41 to 1.24 megapascals (MPa, 60 to 180 pounds per square inch (psi)), whichever occurs first. Then quench the reactions by adding a 0.28 MPa (40 psi) overpressure of 10% volume/volume (v/v) CO₂ in argon. Continue to collect data for 5 minutes after the quench. Cool the PPR reactor down to 50° C., vent it, and remove the glass tube from the dry glovebox. Remove volatiles using a rotary evaporator. Weigh vial to obtain product yield.

Examples 12 to 15: used conventionally-supported catalyst cd-Cat1 in PPR slurry phase batch reactor and the polymerization conditions shown below in Table 5. The properties of the poly(ethylene-co-1-alkene) copolymers made thereby are shown later in Table 6.

TABLE 5
PPR Slurry-Phase Batch Reactor Conditions using cd-Cat1.

| | | C₆/C₂ | H₂/C₂ | C₂ partial | Catalyst | Copol. | Quench |
|---|---|---|---|---|---|---|---|
| Ex | Temp. | molar | molar | press. | charge | Yield | Time |
| No. | (° C.) | ratio | ratio | (Kpa) | (mg) | (g) | (sec.) |
| 12 | 100 | 0.4 | 0.0068 | 690 | 0.7 | 0.0926 | 2128 |
| 13 | 100 | 0.4 | 0.0017 | 690 | 0.7 | 0.1245 | 1557 |
| 14 | 100 | 0.4 | 0.0017 | 690 | 0.5 | 0.0348 | 3600 |
| 15 | 80 | 0.4 | 0.0017 | 690 | 0.5 | 0.0909 | 560 |

Table 5 describes the batch slurry phase PPR reactor polymerization conditions and results for conventionally supported catalyst. Quench time is how long in seconds the slurry phase polymerization was run before it was stopped by the quenching with 40 psi overpressure of 10 volume percent (v/v) of CO₂ in argon. When the polymerization is set to be automatically quenched at the set ethylene uptake amount, the quench time is how long from start of the run until the set ethylene uptake amount is reached, and all other things being equal the shorter the quench time, the more active is the catalyst.

TABLE 6
properties of poly(ethylene-co-1-alkene) copolymers made with
cd-Cat1 in batch slurry phase PPR reactor.

| Ex | Mₙ | M_{w} | | Wt % | SCB/ | |
|---|---|---|---|---|---|---|
| No. | (g/mol) | (g/mol) | M_{w}/Mₙ | C₆ | 1000TC | MWCDI |
| 12 | 41,188 | 194,772 | 4.73 | 3.96 | 4.95 | 2.43 |
| 13 | 82,428 | 483,426 | 5.86 | 4.23 | 5.29 | 2.84 |
| 14 | 103,895 | 408,295 | 3.93 | 16.07 | 20.08 | 1.83 |
| 15 | 90,270 | 540,249 | 5.98 | 12.74 | 15.93 | 2.90 |

Table 6 shows poly(ethylene-co-1-alkene) copolymers of Examples 12 to 15 made with conventionally-supported cd-Cat1 in a slurry phase PPR batch reactor independently have a reverse comonomer distribution and a unimodal molecular weight distribution.

1. A method of making a poly(ethylene-co-1-alkene) copolymer having a reverse comonomer distribution, the method comprising contacting ethylene and at least one 1-alkene with an effective catalyst therefor in a polymerization reactor under effective gas-phase or slurry-phase polymerization conditions so as to give the poly(ethylene-co-1-alkene) copolymer having a reverse comonomer distribution as shown by a molecular weight comonomer distribution index greater than 0 (MWCDI>0); wherein the effective catalyst is made by contacting a ligand-metal complex of formula (I): 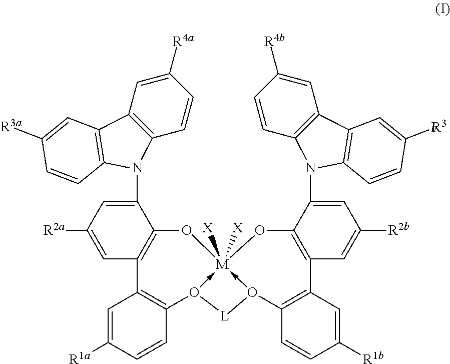
with an activator under effective activating conditions to give the effective catalyst; wherein M is an element of Group 4 of the Periodic Table of the Elements; L is CH₂CH₂CH₂ or an alkyl-substituted 1,3-propan-di-yl; each of R^{1a} and R^{1b} independently is a halogen; and each of R^{2a}, R^{2b}, R^{3a}, R^{3b}, R^{4a}, and R^{4b} independently is an unsubstituted 1,1-dimethyl-(C₂ to C₈)alkyl; and each X independently is a halogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl.

2. The method of claim 1 wherein the ligand-metal complex of formula (I) has any one of features (i) to (vii): (i) L is CH₂CH₂CH₂; (ii) L is the alkyl-substituted 1,3-propan-di-yl; (iii) M is hafnium (Hf); (iv) each of R^{1a} and R^{1b} is F; (v) each of R^{2a} and R^{2b} is unsubstituted 1,1,3,3-teramethyl-butyl; (vi) each of R^{3a}, R^{3b}, R^{4a}, and R^{4b} is unsubstituted 1,1-dimethylethyl; and (vii) each X is unsubstituted (C₁-C₈)alkyl or benzyl.

3. The method of claim 1 wherein the ligand-metal complex of formula (I) is selected from complex (1) and complex (2): complex (1) is the ligand-metal complex of formula (I), wherein M is Hf; L is CH₂CH₂CH₂; each of R^{1a} and R^{1b} is F; each of R^{2a} and R^{2b} is unsubstituted 1,1,3,3-teramethyl-butyl; each of R^{3a}, R^{3b}, R^{4a}, and R^{4b} is unsubstituted 1,1-dimethylethyl; and each X independently is a halogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl; and complex (2) is ligand-metal complex of formula (I) wherein M is Hf; L is —CH(CH₃)CH₂CH(CH₃)—; each of R^{1a} and R^{1b} is F; each of R^{2a} and R^{2b} is unsubstituted 1,1,3,3-teramethyl-butyl; each of R^{3a}, R^{3b}, R^{4a}, and R^{4b} is unsubstituted 1,1-dimethylethyl; and each X independently is a halogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl.

4. The method of claim 3 wherein the ligand-metal complex of formula (I) is the complex (1).

5. The method of claim 1 wherein the poly(ethylene-co-1-alkene) copolymer has a reverse comonomer distribution wherein the MWCDI>0.05 to 4.

6. The method of claim 1 having any one of features (i) to (iii): (i) the activator is an alkylaluminoxane; (ii) the effective catalyst is a supported catalyst that comprises the effective catalyst and a support material that is a solid particulate effective for hosting the ligand-metal complex of formula (I) and its active product, wherein the effective catalyst is disposed on the support material; and (iii) both (i) and (ii).

7. The method of claim 1 wherein the effective catalyst is a spray-dried effective catalyst made by spray-drying a mixture of a hydrophobic fumed silica, activator, and the ligand-metal complex of formula (I) from an inert hydrocarbon solvent so as to give the effective catalyst as a spray-dried supported catalyst.

8. The method of claim 1 wherein the method consists essentially of using the effective catalyst as the only catalyst in a single polymerization reactor under effective steady-state gas-phase or slurry-phase polymerization conditions and the contacting step consists essentially of contacting the ethylene and the at least one 1-alkene with the effective catalyst as the only catalyst in the single polymerization reactor under the effective steady-state gas-phase or slurry-phase polymerization conditions so as to give the poly(ethylene-co-1-alkene) copolymer having a reverse comonomer distribution as a unimodal poly(ethylene-co-1-alkene) copolymer having a reverse comonomer distribution.

9. The method of claim 1 wherein the method consists essentially of using the effective catalyst as the only catalyst in two different polymerization reactors, each polymerization reactor independently having a different set of effective gas-phase or slurry-phase polymerization conditions and making a different poly(ethylene-co-1-alkene) copolymer having a reverse comonomer distribution; and the contacting step consists essentially of contacting first amounts of ethylene and at least one 1-alkene with the effective catalyst in a first polymerization reactor under a first set of effective gas-phase or slurry-phase polymerization conditions so as to make a first unimodal poly(ethylene-co-1-alkene) copolymer having a first reverse comonomer distribution; contacting second amounts of ethylene and at least one 1-alkene with the same effective catalyst in a second polymerization reactor under a second set of effective gas-phase or slurry-phase polymerization conditions so as to make a second unimodal poly(ethylene-co-1-alkene) copolymer having a second reverse comonomer distribution, wherein the second set of effective gas-phase or slurry-phase polymerization conditions is different than the first set of effective gas-phase or slurry-phase polymerization conditions and the second reverse comonomer distribution is different than the first reverse comonomer distribution; and combining the first and second unimodal poly(ethylene-co-1-alkene) copolymers so as to give the poly(ethylene-co-1-alkene) copolymer having a reverse comonomer distribution as a bimodal poly(ethylene-co-1-alkene) copolymer having a combined reverse comonomer distribution.

10. The method of claim 1 wherein the method consists essentially of using a multimodal catalyst system in a single polymerization reactor under effective steady-state gas-phase or slurry-phase polymerization conditions, wherein the multimodal catalyst system consists essentially of the effective catalyst described in any one of claims 1 to 6 (“first effective catalyst”) and at least one different catalyst selected from at least one of a second effective catalyst made from a different ligand-metal complex of formula (I) than that used to make the first effective catalyst, a bis(biphenylphenoxy)-based catalyst by contacting a ligand-metal complex of formula (II) with an activator under activating conditions, a metallocene catalyst, a metallocene catalyst, and a bis((alkyl-substituted phenylamido)ethyl)amine catalyst; and wherein the contacting step consists essentially of contacting the ethylene and the at least one 1-alkene with the multimodal catalyst system in the single polymerization reactor under the effective steady-state gas-phase or slurry-phase polymerization conditions so as to give the poly(ethylene-co-1-alkene) copolymer having a reverse comonomer distribution as a multimodal poly(ethylene-co-1-alkene) copolymer having a reverse comonomer distribution; wherein the ligand-metal complex of formula (II) is: 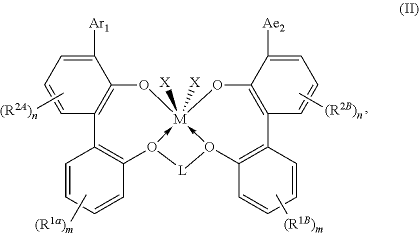
wherein each X independently is a halogen, a (C₁-C₂₀)alkyl, a (C₇-C₂₀)aralkyl, a (C₁-C₆)alkyl-substituted (C₆-C₁₂)aryl, or a (C₁-C₆)alkyl-substituted benzyl; Z is a divalent alkylene linking group having two or more carbon atoms; M is Ti, Hf, or Zr; each of Ar^{l} and Ar² independently is an unsubstituted or substituted phenyl group or an unsubstituted or N-substituted carbazolyl group; each subscript m is an integer from 0 to 4; each subscript n is an integer from 0 to 3; each of R^{1A} and R^{1B} independently is a halogen or a (C₁-C₆)alkyl; each of R^{2A} and R^{2B} independently is a halogen or a (C₁-C₈)alkyl; with the proviso that when each of Ar¹ and Ar² independently is the N-substituted carbazolyl group, formula (II) differs from formula (I) by at least one of the following differences (i) to (xi): (i) Z of formula (II) is not the same as L of formula (I), (ii) R^{1A} of formula (II) is not the same as R^{1a} of formula (I), (iii) R^{1B} of formula (II) is not the same as R^{1b} of formula (I), (iv) R^{2A} of formula (II) is not the same as R^{2a} of formula (I), (v) R^{2B} of formula (II) is not the same as R^{2b} of formula (I), (vi) both (i) and (ii), (vii) both (i) and (iii), (viii) both (i) and (iv), (ix) both (i) and (v), (x) any four of (i) to (v), and (xi) each of (i) to (v).

11. The method of claim 1 further comprising a step of making the effective catalyst by contacting the ligand-metal complex of formula (I) with the activator under the effective activating conditions to give the effective catalyst.

12. The method of claim 1, the method further comprising adding a trim catalyst into a gas-phase or slurry-phase polymerization reactor, wherein the trim catalyst consists essentially of a solution of the effective catalyst in unsupported form dissolved in an inert hydrocarbon solvent.

13. (canceled)

14. A spray-dried, supported effective catalyst made by spray-drying a mixture of a hydrophobic fumed silica, activator, and the ligand-metal complex of formula (I) as described in claim 1 from an inert hydrocarbon solvent so as to give the effective catalyst as a spray-dried supported effective catalyst.

15. A poly(ethylene-co-1-alkene) copolymer having a reverse comonomer distribution made by the method of claim 1.
